(19) United States
(12) Patent Application Publication
(10) Pub. No.: US 2026/0205457 A1
(43) Pub. Date: Jul. 16, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Takeshi KISHIKAWA, Osaka (JP); Tomoyuki HAGA, Nara (JP)

(73) Assignee: Panasonic Intellectual Property Management Co., Ltd., Osaka (JP)

(21) Appl. No.: 19/569,624

(22) Filed: Mar. 17, 2026

Related U.S. Application Data
(63) Continuation of application No. PCT/JP2024/031795, filed on Sep. 5, 2024.

(30) Foreign Application Priority Data
Sep. 29, 2023 (WO) PCT/JP2023/035708

(51) Int. Cl. H04L 9/40

(52) U.S. Cl. CPC H04L 63/10

(57) ABSTRACT

An information processing method is an information processing method executed by an information processing device in a control network system that includes: a plurality of electronic control units each capable of executing a service that includes execution of predetermined processing and capable of mutual access regarding services; and a plurality of edge access permission devices each determining whether to permit or deny the access based on a predetermined access policy. The information processing method includes: obtaining, from the plurality of edge access permission devices, policy verification results, each including a determination result indicating whether the access is permitted or denied; and outputting verification information related to a master policy verification result that includes a final determination result indicating whether the access is permitted or denied, based on the policy verification results from the plurality of edge access permission devices.

### CROSS REFERENCE TO RELATED APPLICATIONS

This is a continuation application of PCT International Application No. PCT/JP2024/031795 filed on September 5, 2024, designating the United States of America, which is based on and claims priority of PCT International Application No. PCT/JP2023/035708 filed on September 29, 2023. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

Conventionally, there has been known the concept of zero trust architecture for reducing security risks (see, for example, Non-Patent Literature 1). In the concept of the conventional zero trust architecture, whether to permit or deny access to a resource by an entity, which is the access source, is determined on the basis of information about the access source.

### Citation List

### Non Patent Literature

NPL 1. Scott Rose, Oliver Borchert, Stu Mitchell, Sean Connelly, “Zero Trust Architecture”, NIST Special Publication 800-207, August 2020, (https://doi.org/10.6028/NIST.SP.800-207)

### SUMMARY

### Technical Problem

It is considered that the application of zero trust architecture to in-vehicle network systems increases the degree of safety. Examples of the resources in an in-vehicle network system include not only personal information of a user but also functions, so-called “services”, provided by Electronic Control Units (ECUs) that constitute the in-vehicle network system.

However, some of the services in a control network system, such as an in-vehicle network system, require real-time performance and/or reliability of communication. The failure of using such services can have impact on the safety of a target object (e.g., mobile object) in which the system is incorporated.

The present disclosure provides an information processing method and so forth capable of realizing a secure control network system while maintaining the safety of a target object in which the control network system is incorporated.

### Solution to Problem

The information processing method according to an aspect of the present disclosure is an information processing method executed by an information processing device in a control network system, wherein the control network system includes: a plurality of electronic control units each capable of executing a service that includes execution of predetermined processing, the plurality of electronic control units being capable of mutual access regarding services; and a plurality of edge access permission devices each determining whether to permit or deny the access based on a predetermined access policy, the information processing method including: obtaining, from the plurality of edge access permission devices, policy verification results, each including a determination result indicating whether the access is permitted or denied; and outputting verification information related to a master policy verification result that includes a final determination result indicating whether the access is permitted or denied, based on the policy verification results from the plurality of edge access permission devices.

The information processing device according to an aspect of the present disclosure is an information processing device in a control network system, wherein the control network system includes: a plurality of electronic control units each capable of executing a service that includes execution of predetermined processing, the plurality of electronic control units being capable of mutual access regarding services; and a plurality of edge access permission devices each determining whether to permit or deny the access based on a predetermined access policy, the information processing device including: an obtainer that obtains, from the plurality of edge access permission devices, policy verification results, each including a determination result indicating whether the access is permitted or denied; and an outputter that outputs verification information related to a master policy verification result that includes a final determination result indicating whether the access is permitted or denied, based on the policy verification results from the plurality of edge access permission devices.

The recording medium according to an aspect of the present disclosure is a non-transitory computer-readable recording medium having recorded thereon a program for a computer to execute the information processing method according to an aspect of the present disclosure.

### Advantageous Effects

With the information processing method and so forth according to an aspect of the present disclosure, it is possible to realize a secure control network system while maintaining the safety of a target object in which the control network system is incorporated.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing the overall configuration of an in-vehicle network system according to an embodiment.

FIG. 2 is a block diagram showing the configuration of a central ECU according to the embodiment.

FIG. 3 is a block diagram showing the functional configuration of a zone ECU according to the embodiment.

FIG. 4 is a block diagram showing the functional configuration of a camera ECU according to the embodiment.

FIG. 5 is a diagram showing an example of an access policy according to the embodiment.

FIG. 6 is a diagram showing an example of a vehicle state according to the embodiment.

FIG. 7 is a diagram showing an example of user information according to the embodiment.

FIG. 8 is a sequence diagram showing the procedure of processing for access permission according to the embodiment.

FIG. 9 is a sequence diagram showing the procedure of processing for access permission according to the embodiment.

FIG. 10 is a flowchart showing the procedure of processing performed by a master policy determiner and a policy implementor of the central ECU according to the embodiment.

FIG. 11 is a flowchart showing the procedure of processing performed by a policy determiner and the policy implementor of the central ECU according to the embodiment.

FIG. 12 is a flowchart showing the procedure of processing, performed by the master policy determiner of the central ECU, of changing critical characteristics in accordance with the vehicle state.

FIG. 13 is a flowchart showing the procedure of processing that is performed when an ECU that has sent a different policy verification result to the central ECU is present according to the embodiment.

FIG. 14 is a diagram showing the configuration of an in-vehicle network system according to Variation 1 of the embodiment.

FIG. 15 is a block diagram showing the functional configuration of a central ECU according to Variation 1 of the embodiment.

FIG. 16 is a block diagram showing the functional configuration of a zone ECU according to Variation 1 of the embodiment.

FIG. 17 is a diagram showing an example of the vehicle state according to Variation 1 of the embodiment.

FIG. 18 is a flowchart showing the procedure of processing, performed by a master policy determiner of the central ECU, of determining thresholds according to Variation 1 of the embodiment.

FIG. 19 is a flowchart showing the procedure of processing that is performed when an ECU that has sent a different policy verification result to the central ECU is present according to Variation 2 of the embodiment.

FIG. 20 is a diagram showing an example of visualizing the situation in which an ECU that has sent a different policy verification result is present according to Variation 2 of the embodiment.

### DESCRIPTION OF EMBODIMENT

Hereinafter, a certain exemplary embodiment is described in greater detail with reference to the accompanying Drawings.

Note that the exemplary embodiment described below is intended to show a specific example of the present disclosure. The numerical values, shapes, elements, steps, the processing order of the steps, etc. shown in the following exemplary embodiment are mere examples, and therefore do not limit the scope of the present disclosure. Therefore, among the elements in the following exemplary embodiment, those not recited in any one of the independent claims are described as optional elements. Furthermore, in all embodiments, the respective contents may be combined. Moreover, the scope of the present disclosure also includes variations obtained by making modifications to each embodiment of the present disclosure within the scope that can be conceived by those skilled in the art, provided they do not depart from the spirit of the present disclosure.

In this DESCRIPTION, terms that express the relationship between elements such as “the same”, the numerical values, and the ranges of numerical values express not only their strict meanings but also mean a substantially equivalent range such as that an error on the order of a few percent (or on the order of 10%) is included.

### Embodiment

### Configuration

First, the in-vehicle network system according to an embodiment is described.

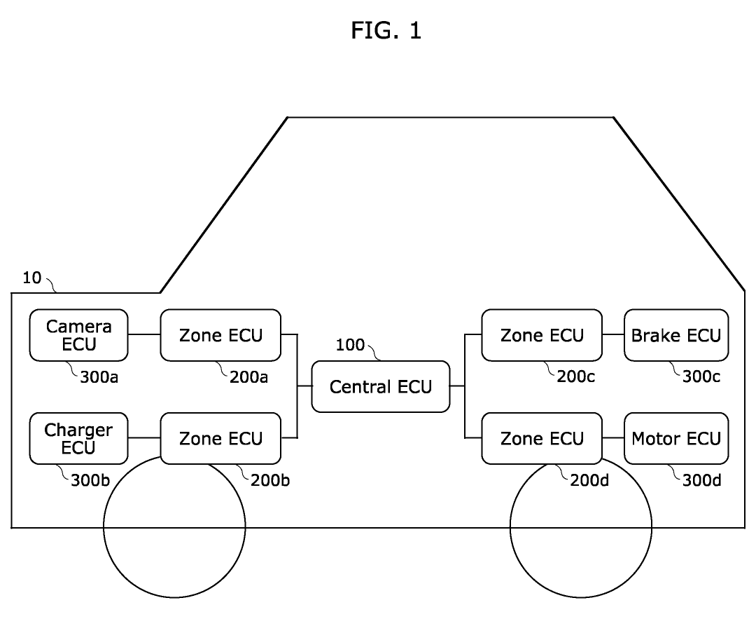

FIG. 1 is a diagram showing the overall configuration of the in-vehicle network system according to the present embodiment.

The in-vehicle network system includes central ECU 100, zone ECUs 200a, 200b, 200c, and 200d (hereinafter also referred to as “zone ECUs such as 200a”), camera ECU 300a, charger ECU 300b, brake ECU 300c, and motor ECU 300d.

The in-vehicle network system is a system for ECUs in vehicle 10 to communicate with each other. For example, camera ECU 300a and zone ECU 200a communicate with each other via an in-vehicle network. Zone ECU 200a communicates with central ECU 100 or zone ECU 200b via the in-vehicle network. The in-vehicle network system is an example of the control network system.

The in-vehicle network is networked on the basis of in-vehicle network communication standards known as Controller Area Network (CAN), LIN, FlexRay, and Ethernet (registered trademark).

Vehicle 10 is used by the user. Examples of vehicle 10 include an automobile, but may also be, for example, a motorcycle, or other mobility systems such as a ship or an aircraft. Vehicle 10 may also be a self-driving vehicle or may be a manually driven vehicle. Vehicle 10 is an example of the target object in which the control network system is incorporated.

Central ECU 100 is an ECU that serves dominant functions for vehicle control. Central ECU 100 has a connectivity function and performs tasks such as notification of the vehicle state via a server external to vehicle 10 and downloading of firmware from such server wirelessly via, for example, a mobile phone network or Wi-Fi (registered trademark). Applications for self-driving are installed in central ECU 100. Central ECU 100 obtains information from each of the ECUs and performs control, thereby realizing self-driving functions. Central ECU 100 is an example of the information processing device or the access permission device.

Zone ECUs 200a to 200d are disposed at various points in the in-vehicle network. Each of zone ECUs 200a to 200d serves as a gateway to a subnetwork and communicates with central ECU 100 or other zone ECUs. Each of zone ECUs 200a to 200d is an example of the edge access permission device.

Camera ECU 300a obtains camera information and sends the obtained camera information to the in-vehicle network.

Charger ECU 300b controls the charging of the battery included in vehicle 10. Charger ECU 300b and zone ECU 200a communicate with each other via the in-vehicle network.

Brake ECU 300c controls the brakes of vehicle 10. Brake ECU 300c and zone ECU 200c communicate with each other via the in-vehicle network.

Motor ECU 300d controls the motor of the automobile. Motor ECU 300d and zone ECU 200d communicate with each other via the in-vehicle network.

Each of the ECUs communicates with other ECUs using, for example, Scalable Service Oriented Middleware over IP (SOME/IP protocol) to, for example, exchange various data items and control instructions. The present embodiment shows an example in which one ECU is connected to each of zone ECUs 200a to 200d, but the number of ECUs connected is not specifically limited to this.

As described above, the in-vehicle network system according to the present embodiment includes: a plurality of ECUs (e.g., camera ECU 300a, charger ECU 300b, brake ECU 300c, motor ECU 300d), each capable of executing a service that includes execution of predetermined processing and capable of mutual access regarding services; and a plurality of zone ECUs such as 200a, each determining whether to permit or deny access on the basis of a predetermined access policy.

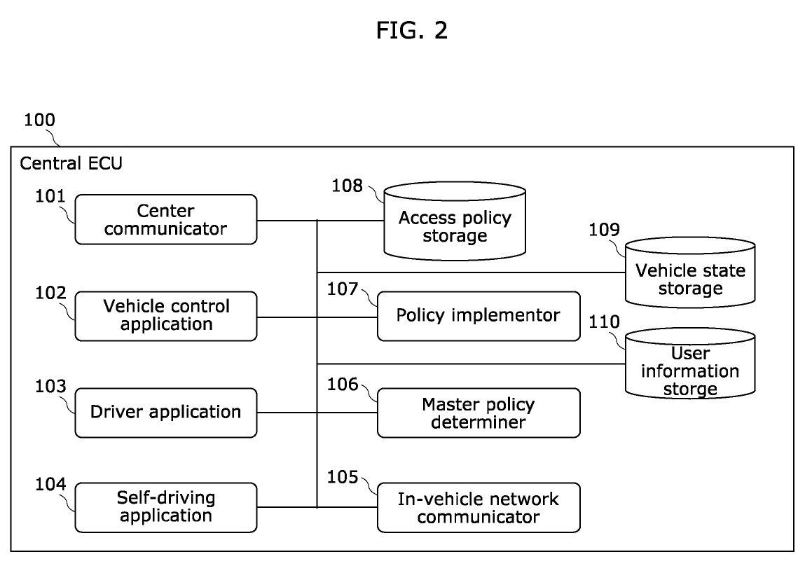

FIG. 2 is a block diagram showing the functional configuration of central ECU 100 according to the present embodiment.

Central ECU 100 includes center communicator 101, vehicle control application 102, driver application 103, self-driving application 104, in-vehicle network communicator 105, master policy determiner 106 (also referred to as master policy decision point), policy implementor 107 (also referred to as policy enforcement point), access policy storage 108, vehicle state storage 109, and user information storage 110. To solve the problem of development time or cost that increases with the growing complexity of in-vehicle network systems, central ECU 100 may also be an ECU in which functions conventionally distributed across a plurality of ECUs are integrated (integrated ECU). In the present embodiment, the master policy determiner 106 functions as the policy decision point (PDP) in a zero trust architecture, while the policy implementor 107 functions as the policy enforcement point (PEP) that enforces an access control decision made at the policy decision point. An integrated ECU is an ECU that utilizes virtualization technology to run a plurality of virtual computers (virtual machines: VMs) on a single ECU. For example, vehicle control application 102, driver application 103, and self-driving application 104 may be implemented in the form of virtual machines. Vehicle control application 102, driver application 103, and self-driving application 104 are separated from each other by virtualization technology from a logical point of view. Also, different IP addresses are assigned to vehicle control application 102, driver application 103, and self-driving application 104.

Center communicator 101 is a communication interface that communicates with a server external to vehicle 10. Center communicator 101 serves as an obtainer that obtains a policy verification result that includes a determination result indicating whether access is permitted or denied. Further, center communicator 101 may also serve as an outputter that outputs, to the external server, verification information related to a master policy verification result.

Vehicle control application 102 is an application that performs control and processing on data obtained from each of the ECUs to realize the basic functions of vehicle 10, such as driving, turning, and stopping.

Driver application 103, which is an application for enhancing the user experience of vehicle 10, controls, for example, the air conditioning or the infotainment system in the vehicle.

Self-driving application 104, which is an application for executing self-driving, obtains sensing information about the outside of the vehicle from ECUs other than central ECU 100, and controls vehicle 10.

In-vehicle network communicator 105, which is a communication interface for the in-vehicle network, exchanges messages with zone ECUs 200a to 200d. In addition, in-vehicle network communicator 105 has a network switch function of controlling the forwarding of communication. In-vehicle network communicator 105 may also serve as an outputter that outputs, to each of the zone ECUs such as 200a, the verification information related to the master policy verification result.

Master policy determiner 106 determines whether to permit or deny access to a vehicle function upon receiving an access request for accessing such vehicle function. More specifically, master policy determiner 106 determines whether the recipient and the sender match regarding the details of a message obtained by in-vehicle network communicator 105, on the basis of the access policy stored in access policy storage 108. When the recipient and the sender match regarding the details of the obtained message, in-vehicle network communicator 105 notifies policy implementor 107 of that access is permitted. When the recipient and the sender do not match regarding the details of the obtained message, in-vehicle network communicator 105 notifies policy implementor 107 of that access is denied. Note that master policy determiner 106 may also determine whether the service ID and the recipient IP address match.

Master policy determiner 106 may also comprehensively determine whether to permit access on the basis of not only the access policy stored in access policy storage 108, but also policy verification results notified from policy determiners 202 disposed in zone ECUs 200a to 200d, which are the results of verifying the access policy. Subsequently, master policy determiner 106 provides an access permission/denial notification to policy implementors 203 of zone ECUs 200a to 200d.

Policy implementor 107 permits or denies access to the vehicle function on the basis of the access permission/denial notification provided from master policy determiner 106. More specifically, policy implementor 107 controls the forwarding or discarding of the message obtained by in-vehicle network communicator 105.

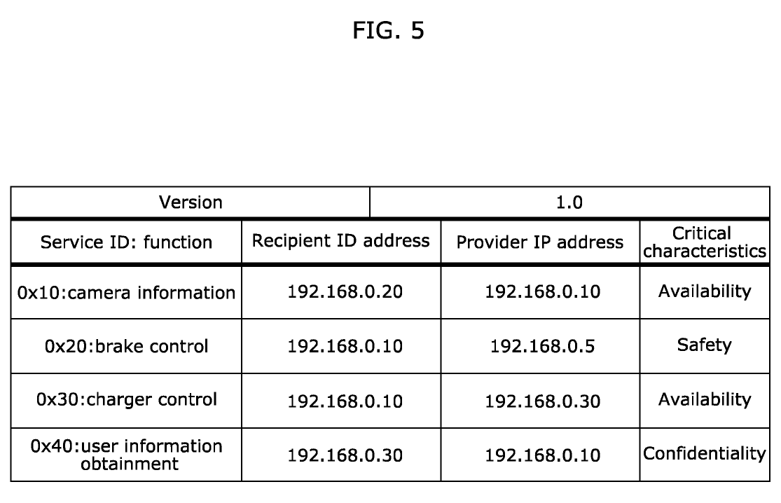

Access policy storage 108 is a storage that stores information related to policies for controlling access to vehicle functions. This will be described in detail later with reference to FIG. 5. Access policy storage 108 is implemented, for example, in the form of a semiconductor memory or a Hard Disk Drive (HDD), but is not limited to this.

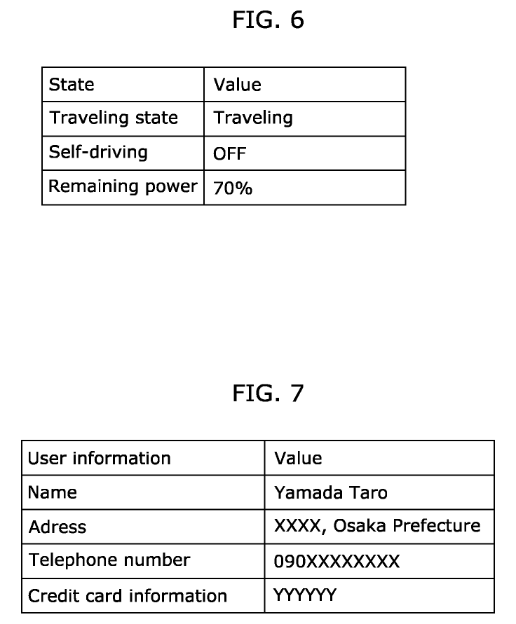

Vehicle state storage 109 is a storage that stores information about the current state of the vehicle. This will be described in detail later with reference to FIG. 6. Vehicle state storage 109 may be implemented, for example, in the form of a semiconductor memory or an HDD, but is not limited to this.

User information storage 110 is a storage that stores user information. This will be described in detail later with reference to FIG. 7. User information storage 110 may be implemented, for example, in the form of a semiconductor memory or an HDD, but is not limited this example.

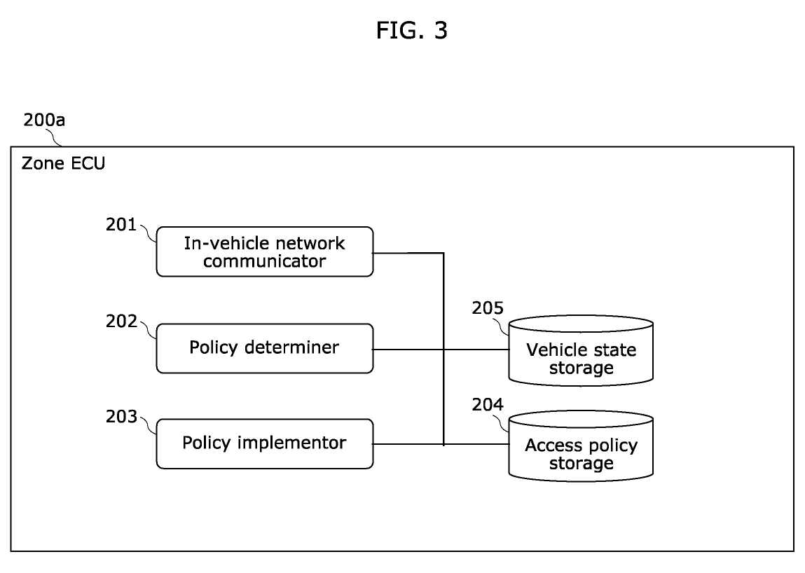

FIG. 3 is a block diagram showing the functional configuration of zone ECU 200a according to the present embodiment. Note that zone ECUs 200b, 200c, and 200d have similar configurations, and thus their descriptions are omitted.

Zone ECU 200a includes in-vehicle network communicator 201, policy determiner 202, policy implementor 203, access policy storage 204, and vehicle state storage 205.

In-vehicle network communicator 201, which is a communication interface for the in-vehicle network, communicates with at least one of central ECU 100 or camera ECU 300a within the zone. Also, in-vehicle network communicator 201 has a network switch function of controlling the forwarding of communication as necessary.

Policy determiner 202 determines whether the recipient and the sender match regarding the details of a message obtained by in-vehicle network communicator 201, on the basis of the access policy stored in access policy storage 204. When the recipient and the sender match regarding the details of the message, policy determiner 202 notifies policy implementor 203 of that access is permitted. When the recipient and the sender do not match regarding the details of the message, policy determiner 202 notifies policy implementor 203 of that access is denied. Note that policy determiner 202 may also determine whether the service ID and the recipient IP address match. The determination result of policy determiner 202 is an example of the policy verification result and includes the determination result indicating whether access is permitted or denied.

Furthermore, depending on the details of a message, policy determiner 202 may notify master policy determiner 106 of central ECU 100 of the result of verifying whether to permit access, rather than policy implementor 203, and master policy determiner 106 may then notify policy implementer 203 of the final determination result indicating whether access is permitted or denied.

Policy implementor 203, which has functions similar to those of policy implementor 107, permits or denies access to the vehicle function on the basis of the access permission/denial notification provided from policy determiner 202 or master policy determiner 106. More specifically, policy implementor 203 controls the forwarding or discarding of messages obtained by in-vehicle network communicator 201. For example, policy implementor 203 forwards a message for which access is permitted and discards a message for which access is denied.

Access policy storage 204 is a storage that stores information related to policies for controlling access to vehicle functions. Access policy storage 204 basically holds information similar to that held by access policy storage 108 included central ECU 100. This will be described in detail later with reference to FIG. 5. Access policy storage 204 is implemented, for example, in the form of a semiconductor memory or an HDD, but is not limited to this.

Vehicle state storage 205 is a storage that stores information about the current state of the vehicle. Vehicle state storage 205 basically holds information similar to that held by vehicle state storage 109 included in central ECU 100. This will be described in detail later with reference to FIG. 6. Vehicle state storage 205 is implemented, for example, in the form of a semiconductor memory or an HDD, but is not limited to this.

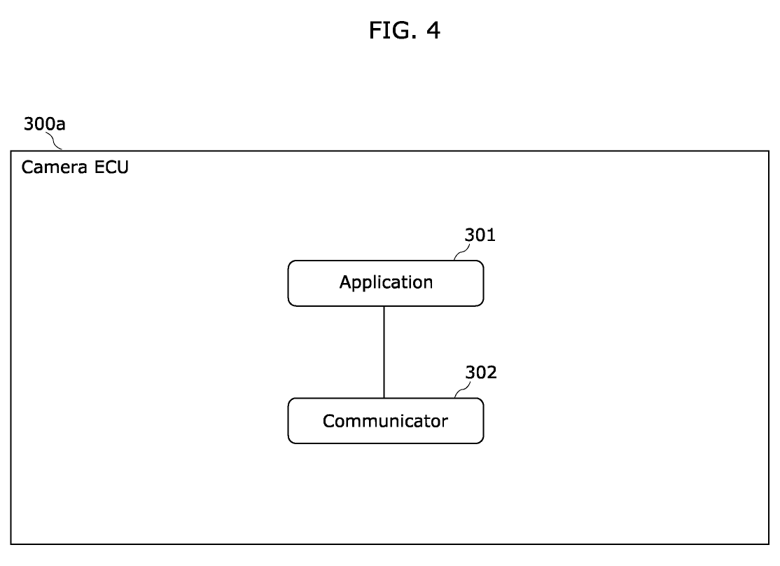

FIG. 4 is a block diagram showing the functional configuration of camera ECU 300a according to the present embodiment. Note that charger ECU 300b, brake ECU 300c, and motor ECU 300d have substantially similar configurations, and thus their descriptions are omitted.

Camera ECU 300a includes application 301 and communicator 302.

Application 301 includes applications that realize ECU functions. A service runs on camera ECU 300a for obtaining camera information and providing the obtained camera information to an ECU requiring such camera information. A service runs on charger ECU 300b for providing the charging state of the battery or for controlling the charging of the battery. A service runs on brake ECU 300c for notifying the brake state or for controlling the brakes. A service runs on motor ECU 300d for notifying the motor state or for controlling the motor.

Communicator 302 is a communication interface for the in-vehicle network and communicates with zone ECU 200a.

### Specific Examples of Various Information Items

The following describes various information items used in the in-vehicle network system according to the embodiment.

FIG. 5 is a diagram showing an example of the access policy according to the present embodiment. The access policy is information stored in each of access policy storages 108 and 204. The access policy stored in access policy storages 108 and 204 is, for example, identical information (synchronized information).

The access policy is information indicating, for each function (service ID), the recipient IP address and the provider IP address, and further defines, for each function, the critical characteristics. The access policy also holds the version information of the access policy. At least a service ID and a recipient IP address are information items included in messages (access request for accessing a vehicle function and discovery message to be described later).

FIG. 5 shows that: the version of the access policy is 1.0; the functions of vehicle 10 include camera information (Service ID: 0x10), brake control (Service ID: 0x20), charger control (Service ID: 0x30), and user information obtainment (Service ID: 0x40); the IP addresses of recipients permitted to receive the services of the respective functions are, in order, 192.168.0.20, 192.168.0.10, 192.168.0.10, 192.168.0.30; the IP addresses of providers that are permitted to provide services are, in order, 192.168.0.10, 192.168.0.5, 192.168.0.30, 192.168.0.10; and the critical characteristics are, in order, availability, safety, availability, and confidentiality.

Communication in the in-vehicle network may be realized, for example, using SOME/IP. A service ID corresponds to a Message ID or a Service ID in SOME/IP. Note that the in-vehicle protocol for the in-vehicle network is not limited to SOME/IP.

The critical characteristics are classified into availability, safety, and confidentiality. The critical characteristics are simply required to include at least two of availability, safety, and confidentiality.

Availability is assigned to services for which service continuity is a critical factor. Such services include, for example, a service where blockage of information, such as camera information, a notification of the state of vehicle 10, etc. could impact vehicle control. Examples of the services requiring availability (first services) include, but are not limited to, the exchange of sensor data obtained by a sensor such as a camera.

Since real-time performance or service continuity is required for a service for which availability is critical, master policy determiner 106 or policy determiner 202 more carefully determines whether to block communication of such service than for safety or confidentiality. Stated differently, master policy determiner 106 determines whether to deny access on the basis of the results from a plurality of policy determiners 202, rather than on the basis of the result from a single policy determiner 202. Furthermore, since real-time performance is required, master policy determiner 106 performs access control to cause communication to be permitted until access is determined to be denied.

Safety is assigned to services that can directly impact vehicle control. Such services include, for example, a service for controlling the brakes or the motor in response to an instruction for controlling the brakes or the motor. Examples of the services requiring safety (third services) include, but are not limited to, a service related to the control an actuator for which real-time performance is required.

For a service for which safety is critical, it is necessary to immediately block an unauthorized access to the service. Further, since such service is related to the control of vehicle 10, real-time performance is also required. For this reason, whether to permit or deny access to the service is determined on the basis of the determination by a single policy determiner 202. For example, each of the zone ECUs such as 200a determines whether to permit or deny access to the service in the own device on the basis of the policy verification result from its own policy determiner 202.

Confidentiality is assigned to services in which information included in the services should not be read by applications other than authorized applications. Such services include, for example, a service that provides information related to personal information of the user. Examples of the services requiring confidentiality (second services) include, but are not limited to, the exchange of data related to personal information or confidential information.

For a service for which confidentiality is critical, real-time performance is not required, but access permission needs to be carefully determined. For this reason, regarding communication related to such service, master policy determiner 106 or policy determiner 202 determines whether to permit access on the basis of the results from the plurality of policy determiners 202. Furthermore, each of the zone ECUs performs access control to cause communication to be held until master policy determiner 106 determines to permit access.

Note that the functions are not limited to the examples shown in FIG. 5, and thus other functions may be included.

Also, values are not required to be set to both a recipient IP address and a provider IP address, and thus a value may be set to one of these IP addresses. Also, a plurality of IP addresses may be set. For example, the access policy may include information related to at least one of ECUs permitted to access a service among the plurality of ECUs or ECUs permitted to provide the service among the plurality of ECUs.

Also, the information indicating a recipient and a provider does not have to be IP addresses. The information indicating a recipient and a provider, may also be, for example, a MAC address or identifiers for identifying ECUs or applications.

Also, a service ID may be anything that represents an identifier of the service. The service ID may be included in a message. The service ID may also be a port number.

Also, there may be services to which critical characteristics are not set. Whether to permit or deny access to a service to which critical characteristics are not set may be determined in accordance with default criteria (e.g., determination by a single policy determiner 202).

Furthermore, the access policy may be encrypted and held in access policy storages 108 and 204.

Also, access control may be set to the access policy to prevent reference other than by master policy determiner 106 and policy determiner 202.

Furthermore, the access policy may be updated on the basis of a formal procedure. The formal procedure may be, for example, a procedure in which the access policy is updated after verifying that the version of the access policy received from the external server is not rolled back and that the digital signature of the access policy is valid.

FIG. 6 is a diagram showing an example of the vehicle state according to the present embodiment. The vehicle state is information stored in vehicle state storages 109 and 205.

The current state of the vehicle that is based on information notified via the in-vehicle network is stored as the vehicle state. More specifically, vehicle state storages 109 and 205 hold, as the vehicle state, the traveling state of vehicle 10, ON/OFF of the self-driving mode, and the state of the remaining battery power. FIG. 6 shows an example of the vehicle state indicating that the traveling state is “travelling”, self-driving is “OFF”, and the remaining battery power is 70%.

Master policy determiner 106 and policy determiner 202 can change the critical characteristics of the services in the access policy in accordance with the vehicle state. For example, when vehicle 10 is currently stopped, master policy determiner 106 and policy determiner 202 use the vehicle state to support the case where the characteristics that are deemed critical for a service change in accordance with the current state of the vehicle, such as by changing the critical characteristics of the charger control service to safety.

Note that the vehicle state is not limited to the example shown in FIG. 6, and thus may also include, for example, a diagnostic mode state or an update state. The diagnostic mode state indicates, for example, the mode (e.g., ON/OFF) of the self-diagnostic function of each of the ECUs. The update state indicates the update state (e.g., version) of each of the applications installed in vehicle 10 and the access policy.

FIG. 7 is a diagram showing an example of the user information according to the present embodiment. The user information is information stored in user information storage 110.

More specifically, user information storage 110 holds, as the user information, the name, the address, the telephone number, and the credit card information of the user of the vehicle. The name of the user of the vehicle may be, for example, the name of the user currently using vehicle 10.

In the example shown in FIG. 7, the name of the user is “Taro Yamada”, the address is “XXXX, Osaka Prefecture”, the telephone number is “090XXXXXXXX”, and the credit card information is “YYYYYY”.

Note that the user information held by user information storage 110 is not limited to the information shown in FIG. 7. As the user information, user information storage 110 may also hold, for example, address book information and favorite location information obtained from an information terminal of the user such as a smartphone.

Furthermore, the user information may be encrypted and held in user information storage 110.

### Processing Procedures

The following describes the procedures of processing performed by the in-vehicle network system according to the present embodiment.

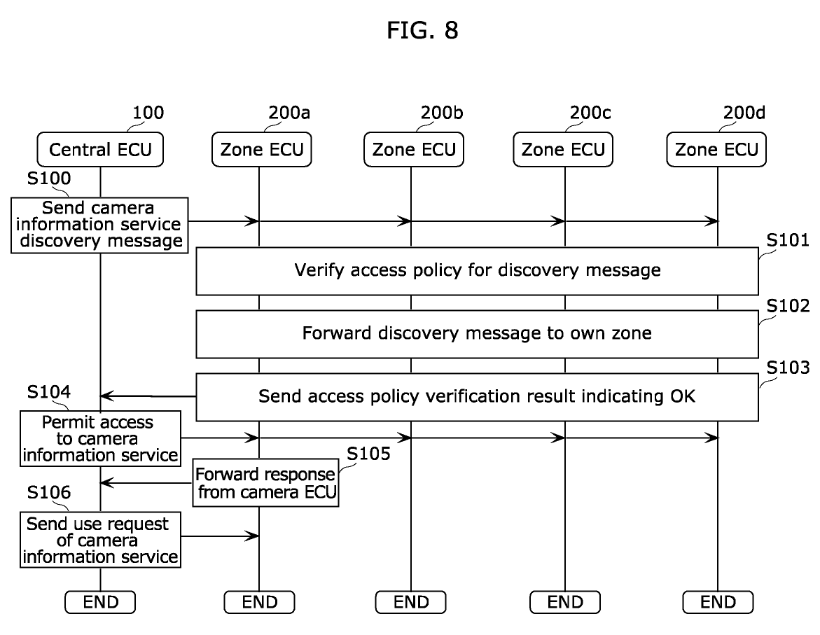

FIG. 8 is a sequence diagram showing the procedure of processing for access permission (information processing method, access permission method) according to the present embodiment. More specifically, FIG. 8 is a sequence diagram showing the sequence in which the self-driving application in central ECU 100 tries accessing the camera information service of camera ECU 300a.

First, central ECU 100 sends a camera information service discovery message for requesting the use of the camera information service at the timing at which, for example, the self-driving function is turned ON (S100). A SOME/IP-Service Discovery (SD) message (Find message) is broadcast as the camera information service discovery message from central ECU 100 to zone ECUs 200a, 200b, 200c, and 200d.

Upon obtaining the camera information service discovery message, each of zone ECUs 200a, 200b, 200c, and 200d verifies whether the message complies with the access policy (S101). Stated differently, upon obtaining the camera information service discovery message, each of zone ECUs 200a, 200b, 200c, and 200d verifies the access policy for the discovery message.

The camera information service discovery message includes the ID of the camera information (e.g., 0×10 in the example shown in FIG. 5) as the service ID and the recipient IP address (the IP address of central ECU 100 or the application that has sent the discovery message). In step S101, policy determiner 202 of each of the zone ECUs verifies the compliance, on the basis of the ID of the camera information and the recipient IP address included in the discovery message, and the access policy shown in FIG. 5. For example, policy determiner 202 of each of the zone ECUs determines whether the pair of the ID of the camera information and the recipient IP address included in the discovery message is included in the access policy shown in FIG. 5.

Subsequently, since the critical characteristics of the camera information service are availability, each of zone ECUs 200a, 200b, 200c, and 200d first forwards the camera information service discovery message to its own zone (S102). When each of the zone ECUs such as 200a does not have a grasp of whether a camera ECU that can provide the camera information service is connected to its own zone and when the critical characteristics are availability, each of the zone ECUs such as 200a once forwards the discovery message regardless of the result in step S101. Note that when each of the zone ECUs such as 200a has a grasp of (stores) information about the service that the ECU in its own zone can provide, the process in step S102 may be omitted.

Furthermore, each of zone ECUs 200a, 200b, 200c, and 200d responds (sends a response) to central ECU 100 to notify that there is no problem (OK) in the result of verifying the access policy (policy verification result) (S103). In step S103, the result of the process in step S101 (verification result) is sent to central ECU 100, which is the recipient ECU. Step S103 is performed independently of the process in step S102.

Since all of the policy verification results from zone ECUs 200a, 200b, 200c, and 200d indicate OK, central ECU 100 is permitted to access the camera information service and a permission notification is also provided to zone ECUs 200a, 200b, 200c, and 200d (S104).

In step S104, master policy determiner 106 of central ECU 100 outputs the master policy verification result (here, access permission), which is the final determination result on the camera information service discovery message sent in step S100 indicating whether access is permitted or denied, on the basis of the policy verification results sent from zone ECUs 200a, 200c, and 200d.

Zone ECU 200a forwards, to central ECU 100, the response (SOME/IP-SD message (Offer message)) received from camera ECU 300a in its own zone (S105). Stated differently, zone ECU 200a forwards the response from camera ECU 300a to central ECU 100. Such response indicates that camera ECU 300a possesses camera information, in response to the forwarding of the discovery message in step S102. With this, it is possible for central ECU 100 to determine which one of the zone ECUs camera ECU 300a is connected to.

Central ECU 100 sends a message for requesting the use of the camera information service (use request) to zone ECU 200a on the basis of the Offer message received from camera ECU 300a (S106). Subsequently, a session is established between central ECU 100 and camera ECU 300a, thereby enabling central ECU 100 to use the camera information service. The use request is an example of the verification information related to the master policy verification result.

Note that the timing at which the response indicating the access policy verification result in step S103 is sent is not limited to a specific timing. Furthermore, depending on the timing at which the response indicating the access policy verification result is sent in step S103, the determination of whether to permit access to the camera information service in step S104 may be performed later than step S105. However, since the critical characteristics of the camera information service are availability, the response from camera ECU 300a is forwarded to central ECU 100 in any cases.

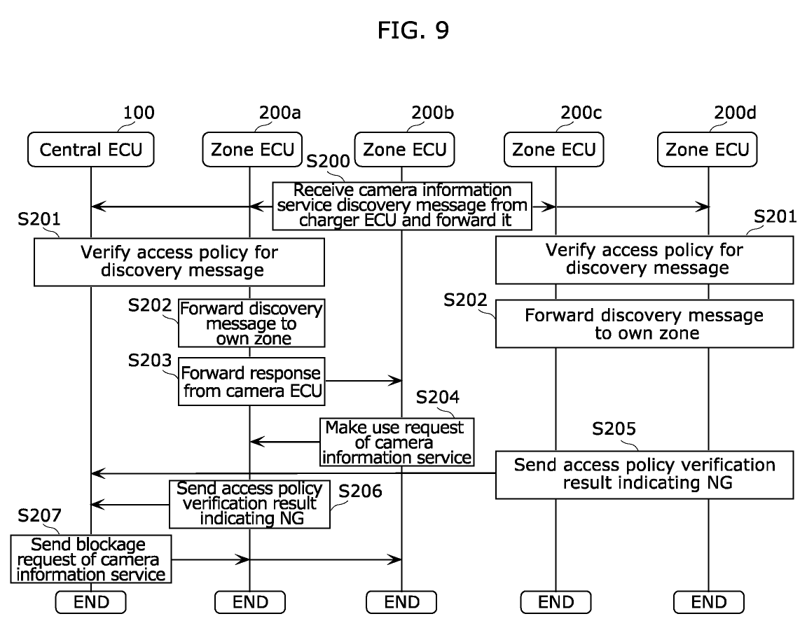

FIG. 9 is a sequence diagram showing the sequence in which charger ECU 300b exhibiting improper behavior tries accessing the camera information service of camera ECU 300a (information processing method, access permission method) according to the present embodiment.

First, zone ECU 200b receives a camera information service discovery message sent from charger ECU 300b, and forwards the message to the other zone ECUs 200a, 200c, and 200d, and central ECU 100 after verifying the access policy for such message (S200).

Central ECU 100 and zone ECUs 200a, 200c, and 200d, to which the camera information service discovery message has been forwarded, verify the access policy for such discovery message (received message) (S201). The method of verifying the access policy is the same as the method used in step S101 shown in FIG. 8.

Each of zone ECUs 200a, 200c, and 200d forwards the camera information service discovery message to its own zone (S202).

Camera ECU 300a sends a camera information service Offer message to zone ECU 200a, and zone ECU 200a then forwards such message to zone ECU 200b (S203). The message is then forwarded to charger ECU 300b. Stated differently, zone ECU 200b forwards the response from camera ECU 300a to charger ECU 300b.

Next, charger ECU 300b sends a message for requesting the use of the camera information service to camera ECU 300a via zone ECUs 200b and 200a (S204).

Subsequently, zone ECUs 200c and 200d send, to central ECU 100, the verification result indicating that the use of the camera information service by charger ECU 300b violates the access policy (NG) (S205).

Similarly, zone ECU 200a also sends, to central ECU 100, the verification result indicating that the access policy is violated (NG) (S206).

Central ECU 100 makes a comprehensive judgment from the access policy verification results received from zone ECUs 200a, 200c, and 200d to provide (send) a message (camera information service blockage request) for prohibiting charger ECU 300b, which is violating the access policy, from accessing the camera information service to zone ECU 200a and zone ECU 200b that are zone ECUs concerned (S207). Stated differently, central ECU 100 requests zone ECU 200a and zone ECU 200b to block the camera information service. In step S207, when the number of policy verification results indicating that access is NG (access is denied) among the policy verification results is at a threshold or more, for example, master policy determiner 106 of central ECU 100 sends a master policy verification result indicating that access is denied (here, the blockage request) to zone ECU 200a, which is connected to camera ECU 300a, and zone ECU 200b, which is connected to charger ECU 300b, among the plurality of zone ECUs such as 200a.

In step S207, master policy determiner 106 of central ECU 100 outputs the master policy verification result (here, a blockage request because the determination result indicates access denial), which is the final determination result on the camera information service discovery message received in step S200, indicating whether access is permitted or denied, on the basis of the access policy verification results sent from zone ECUs 200a, 200c, and 200d. The blockage request is an example of the verification information related to the master policy verification result.

Subsequently, communication performed between charger ECU 300b and camera ECU 300a related to the camera information service is blocked by zone ECU 200a or zone ECU 200b, as a result of which unauthorized use of the camera information service by charger ECU 300b is prohibited.

In this case, charger ECU 300b is an example of the one electronic control unit and camera ECU 300a is an example of the other electronic control unit. Furthermore, the sending of the discovery message is an example of the access made by charger ECU 300b to the service of camera ECU 300a.

Note that the blockage request in step S207 may further be notified (sent) to each of plurality of zone ECUs such as 200a, including zone ECUs 200c and 200d.

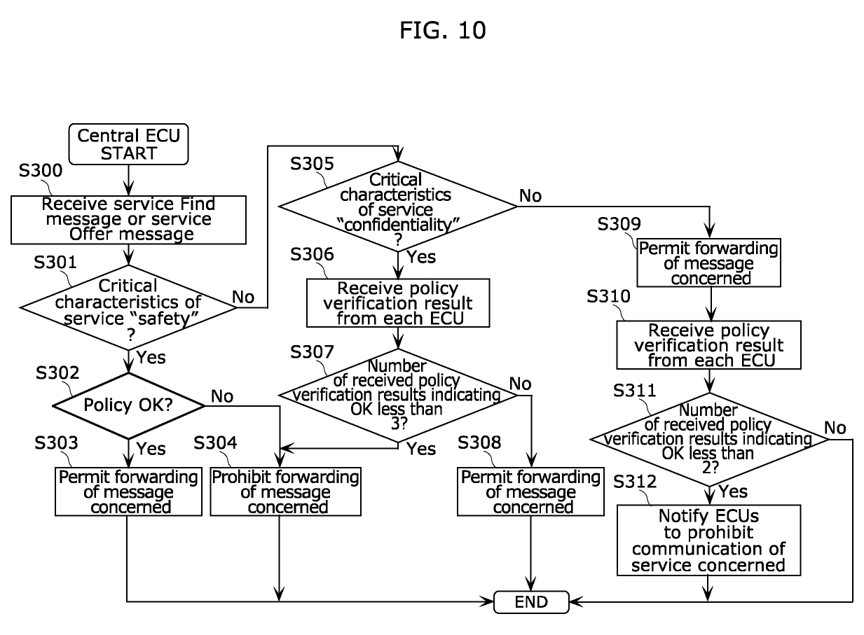

FIG. 10 is a flowchart showing the details of the processing performed by master policy determiner 106 and policy implementor 107 in central ECU 100 (information processing method, access permission method) according to the present embodiment.

First, central ECU 100 receives a SOME/IP-SD message (service Find message or service Offer message) from the in-vehicle network (S300). The service Find message is a message for the recipient (client side) to find a provider (server side) that provides a service. The service Find message is a message indicating which ECU is searching for which service. The service Offer message is a message sent from the server side (e.g., camera ECU 300a) to notify information it possesses (can provide). The service Offer message is a message indicating which ECU can provide which service.

Central ECU 100 identifies the service ID of the service, included in the received SOME/IP-SD message, to be provided or requested, and references to access policy storage 108 to determine whether the critical characteristics of the service related to the received message are safety (S301). Master policy determiner 106 of central ECU 100 determines whether the critical characteristics of the service ID included in the service Find message or the service Offer message are safety, on the basis of the access policy shown in FIG. 5. As shown in FIG. 5, service IDs and critical characteristics are in one-to-one correspondence in the access policy.

Note that the received SOME/IP-SD message can include a plurality of service IDs, in which case central ECU 100 may identify all of the service IDs to determine whether any service requiring safety is included.

Furthermore, zone ECU 200a may divide a SOME/IP-SD message including different critical characteristics on a service ID basis and forward the resulting SOME/IP-SD messages. When a SOME/IP-SD message includes service IDs with different critical characteristics, such as safety and availability, for example, central ECU 100 may create a SOME/IP-SD message that includes only the service ID with the critical characteristics of availability and forward such created message first. Furthermore, central ECU 100 may verify the service policy for the SOME/IP message itself, rather than for the SOME/IP-SD message.

When it is determined that the critical characteristics of the service related to the received message are safety (Yes in S301), central ECU 100 verifies the access policy to determine whether the provider and the recipient of the service conform to the access policy (S302).

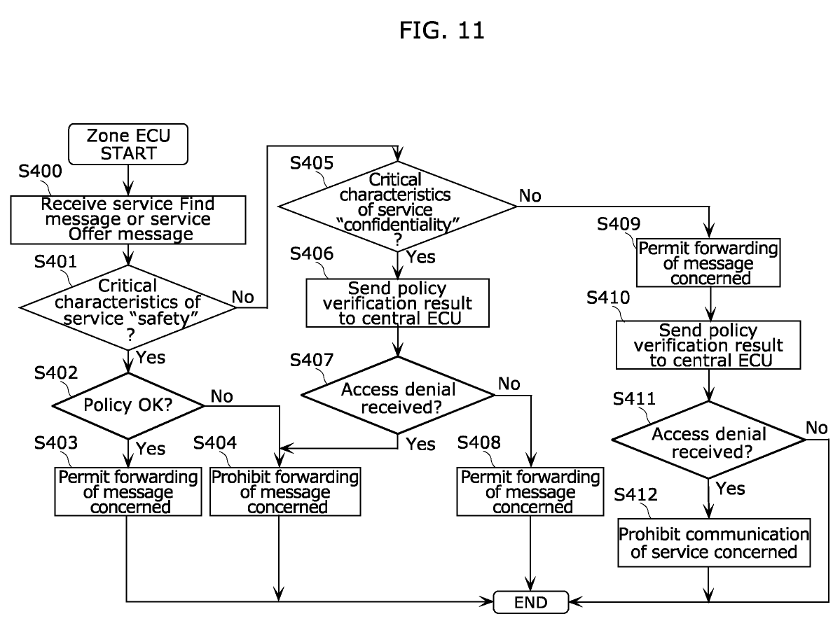

Next, when it is determined that the received message conforms to the access policy (Yes in S302), central ECU 100 permits the forwarding of such message (S303) and terminates the processing. In step S303, only messages passing through central ECU 100 are permitted. In this case, as described later with reference to FIG. 11, the zone ECUs such as 200a individually determine whether the access policy is OK. Furthermore, the message in step S303 refers to a normal SOME/IP message, and may be, for example, a message for sending camera information (image information). Such message is a message received after the service Find message and not a service Discovery message.

For a service with the critical characteristics of safety (third service), it can be said that central ECU 100 permits the plurality of zone ECUs such as 200a to individually determine whether to permit or deny access to the service in such zone ECU on the basis of the policy verification result of such zone ECU, before the master policy verification result is outputted.

When it is determined that the received message does not conform to the access policy (No in S302), central ECU 100 prohibits the forwarding of such message (S304) and terminates the processing.

When it is determined that the critical characteristics of the service related to the received message are not safety (No in S301), central ECU 100 determines whether the critical characteristics of the service related to the received message are confidentiality (S305).

Next, when it is determined that the critical characteristics of the service related to the received message are confidentiality (Yes in S305), central ECU 100 receives, from zone ECUs 200a, 200b, 200c, and 200d, the policy verification results related to the message (S306).

Furthermore, central ECU 100 determines whether the number of policy verification results indicating OK received from zone ECUs 200a, 200b, 200c, and 200d is less than a threshold (here, 3) (S307). When confidentiality is required for data, it means that such data is important. As such, central ECU 100 obtains the determination results from other zone ECUs to comprehensively determine whether to permit or deny access. The value of the threshold used in step S307 is greater than the value of the threshold used in step S311, but is not limited to this.

When it is determined that the number of policy verification results indicating OK received from zone ECUs 200a, 200b, 200c, and 200d is less than 3 (Yes in S307), central ECU 100 prohibits the forwarding of the message (S304).

On the other hand, when it is determined that the number of policy verification results indicating OK received from zone ECUs 200a, 200b, 200c, and 200d is 3 or more (No in S307), central ECU 100 permits the forwarding of the message (S308) and terminates the processing.

When it is determined that the critical characteristics of the service related to the received message are not confidentiality (No in S305), central ECU 100 permits the forwarding of such message (S309), because the critical characteristics of the service related to the message are availability.

Next, central ECU 100 receives the policy verification results related to the message from zone ECUs 200a, 200b, 200c, and 200d (S310).

After that, central ECU 100 determines whether the number of policy verification results indicating OK received from zone ECUs 200a, 200b, 200c, and 200d is less than 2 (S311). For example, in steps S205 and S206 shown in FIG. 9, all results indicate NG, and thus it is determined that the number of received results is 0, that is, less than 2.

When it is determined that the number of policy verification results indicating OK received from zone ECUs 200a, 200b, 200c, and 200d is less than 2 (Yes in S311), central ECU 100 notifies zone ECUs 200a, 200b, 200c, and 200d to prohibit communication of the service violating the access policy (S312) and terminates the processing. Step S312 corresponds to step S207 shown in FIG. 9.

On the other hand, when it is determined that the number of policy verification results indicating OK received from zone ECUs 200a, 200b, 200c, and 200d is less than 2 (No in S311), central ECU 100 terminates the processing. In this case, the state permitted in step S309 continues. As described above, for a service requiring availability as the critical characteristics, the processing is performed in a manner that permission is once granted (S309) and then prohibited later (S312) when something unusual is detected (Yes in S311).

The threshold for the number of policy verification results indicating OK received from zone ECUs 200a, 200b, 200c, and 200d, which is the threshold on the basis of which the processing of central ECU 100 branches, is not limited to the value shown in the present embodiment. The threshold may be changed in accordance with the configuration of the in-vehicle network, the number of zone ECUs deployed, and the details of a message.

Furthermore, the number of received policy verification results indicating OK may include not only the policy verification results from zone ECUs 200a, 200b, 200c, and 200d, but also a policy verification result from master policy determiner 106 of central ECU 100.

The flowchart illustrates an example in which the access policy is verified for a SOME/IP-SD message, but the target subjected to access restriction is not limited to a SOME/IP-SD message. The target to be subject to access restriction may also be, for example, a SOME/IP message, a Data Distribution Service (DDS) message, etc.

Furthermore, in the flowchart, central ECU 100 prohibits the forwarding of the message in step S304, that is, the forwarding of the SOME/IP-SD message. However, central ECU 100 may forward the SOME/IP-SD message and prohibit the forwarding of a subsequent message related to such service, or notify other zone ECUs to prohibit communication that does not conform to the access policy.

FIG. 11 is a flowchart showing the details of the processing of determining access permission performed by zone ECU 200a (information processing method, access permission method) according to the present embodiment. Note that zone ECUs 200b, 200c, and 200d also perform similar processing.

First, zone ECU 200a receives a SOME/IP-SD message (service Find message or service Offer message) from the in-vehicle network (S400).

Zone ECU 200a identifies the service ID of the service, included in the received SOME/IP-SD message, to be provided or requested, and references to access policy storage 204 to determine whether the critical characteristics of the service related to the received message are safety (S401). Policy determiner 202 of zone ECU 200a determines whether the critical characteristics of the service ID included in the service Find message or the service Offer message are safety, on the basis of the access policy shown in FIG. 5.

Note that the received SOME/IP-SD message can include a plurality of service IDs, in which case zone ECU 200a may identify all of the service IDs to determine whether any service requiring safety is included.

Furthermore, zone ECU 200a may divide a SOME/IP-SD message including different critical characteristics on a service ID basis and forward the resulting SOME/IP-SD messages. When a SOME/IP-SD message includes service IDs with different critical characteristics such as safety and availability, for example, zone ECU 200a may create a SOME/IP-SD message that includes only the service ID with the critical characteristics of availability and forward such created message first. Furthermore, zone ECU 200a may verify the service policy for the SOME/IP message itself, rather than for the SOME/IP-SD message.

When it is determined that the critical characteristics of the service related to the received message are safety (Yes in S401), zone ECU 200a verifies the access policy to determine whether the provider and the recipient of the service conform to the access policy (S402).

Next, when it is determined that the received message conforms to the access policy (Yes in S402), zone ECU 200a permits the forwarding of such message (S403) and terminates the processing. In step S403, only messages passing through zone ECU 200a are permitted.

When it is determined that the received message does not conform to the access policy (No in S402), zone ECU 200a prohibits the forwarding of such message (S404) and terminates the processing.

When it is determined that the critical characteristics of the service related to the received message are not safety (No in 401), zone ECU 200a determines whether the critical characteristics of the service related to the received message are confidentiality (S405).

Next, when it is determined that the critical characteristics of the service related to the received message are confidentiality (Yes in S405), zone ECU 200a sends, to central ECU 100, the policy verification result related to such message (S406).

Furthermore, zone ECU 200a receives the final determination result indicating whether access is permitted or denied (master policy verification result) from central ECU 100 and determines whether the determination result indicates that access is denied (NG) (S407).

When zone ECU 200a receives, from central ECU 100, the final determination result indicating that access is denied (NG) (Yes in S407), zone ECU 200a prohibits the forwarding of the message (S404).

On the other hand, when zone ECU 200a receives the final determination result indicating that access is permitted (OK) (No in S407), zone ECU 200a permits the forwarding of the message (S408) and terminates the processing.

When it is determined that the critical characteristics of the service related to the received message are not confidentiality (No in S405), zone ECU 200a permits the forwarding of such message (S409), because the critical characteristics of the service related to the message are availability.

Next, zone ECU 200a sends, to central ECU 100, the policy verification result of zone ECU 200a related to the message (S410).

Subsequently, zone ECU 200a receives the final determination result indicating whether access is permitted or denied (master policy verification result) from central ECU 100 and determines whether the determination result indicates that access is denied (NG) (S411).

When zone ECU 200a determines that the received final determination result indicates that access is denied (Yes in S411), zone ECU 200a prohibits communication of the service violating the access policy (S412) and terminates the processing.

On the other hand, when zone ECU 200a determines that the final determination result indicates that access is permitted (No in S411), zone ECU 200a terminates the processing without taking any action. In this case, the state permitted in step S409 continues. As described above, for a service requiring availability as the critical characteristics, the processing is performed in a manner that permission is once granted (S409) and then prohibited later (S412) when something unusual is detected (Yes in S411).

Note that the flowchart illustrates an example in which the access policy is verified for a SOME/IP-SD message, but the target subjected to access restriction is not limited to a SOME/IP-SD message. For example, the target to be subject to access restriction may also be, for example, a SOME/IP message, a DDS message, etc. Furthermore, in the flowchart, zone ECU 200a prohibits the forwarding of such message in step S404, that is, the forwarding of the SOME/IP-SD message. However, zone ECU 200a may forward the SOME/IP-SD message and prohibit the forwarding of a subsequent message related to that service.

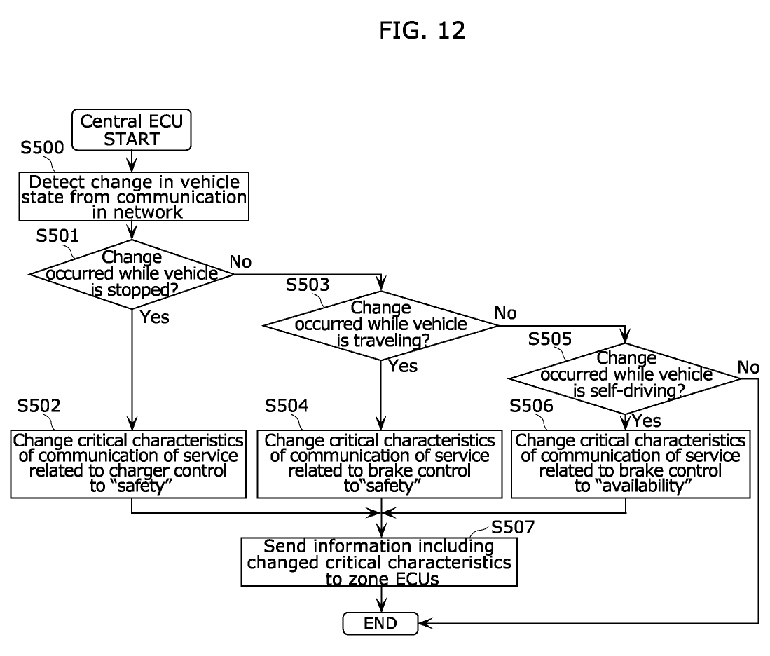

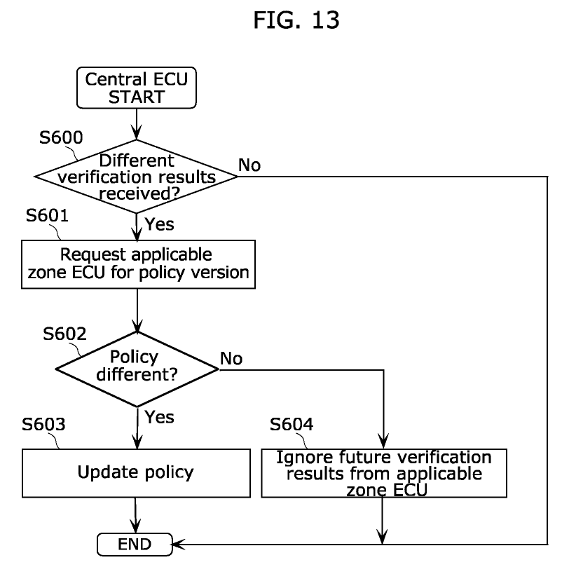

FIG. 12 is a flowchart showing the processing, performed by master policy determiner 106 of central ECU 100, of changing the critical characteristics of services held in access policy storage 108 in accordance with the vehicle state held in vehicle state storage 109 (information processing method, access permission method) according to the present embodiment. Note that policy determiners 202 of zone ECUs 200a, 200b, 200c, and 200d perform similar processing.

First, central ECU 100 receives a message from communication in the in-vehicle network and detects a change in the vehicle state from the contents of the communication (S500). In step S500, central ECU 100 determines whether the vehicle state has changed.

Central ECU 100 determines whether the traveling state included in the vehicle state has been changed (or changed) while the vehicle is stopped (S501).

When it is determined that the traveling state included in the vehicle state has changed while the vehicle is stopped (Yes in S501), central ECU 100 changes the critical characteristics of the communication of the service related to charger control to safety (e.g., from availability to safety) (S502) and proceeds to step S507.

When it is determined that the traveling state included in the vehicle state has not changed while the vehicle is stopped (No in S501), central ECU 100 determines whether the traveling state included in the vehicle state has been changed (has changed) while the vehicle is traveling (S503).

When it is determined that the traveling state included in the vehicle state has changed while the vehicle is traveling (Yes in S503), central ECU 100 changes the critical characteristics of the communication of the service related to brake control to safety (S504) and proceeds to step S507.

When it is determined that the traveling state included in the vehicle state has not changed while the vehicle is traveling (No in S503), central ECU 100 determines whether the self-driving mode included in the vehicle state has changed to ON (S505). Stated differently, in step S505, it is determined whether the vehicle state has changed while the vehicle is self-driving.

When it is determined that the self-driving mode included in the vehicle state has changed to ON (Yes in S505), central ECU 100 changes the critical characteristics of the communication of the service related to brake control to availability (e.g., from safety to availability) (S506) and proceeds to step S507.

Next, central ECU 100 sends information including the changed critical characteristics to each of the zone ECUs such as 200a (S507). Central ECU 100 may send the access policy including the changed critical characteristics to each of the zone ECUs such as 200a. Then, central ECU 100 terminates the processing.

On the other hand, when it is determined that the self-driving mode included in the vehicle state has not changed to ON (No in S505), central ECU 100 terminates the processing.

Note that in changing the critical characteristics, the contents stored in access policy storage 108 may be changed as shown in the flowchart. Alternatively, the critical characteristics may be changed by referencing to the vehicle state stored in vehicle state storage 109 at the timing at which access policy storage 108 is referenced to, as shown in FIG. 10.

With this, the critical characteristics change in accordance with the vehicle state, even when the same service ID is concerned. This enables the result of determining whether to permit or deny access to differ in accordance the vehicle state. Consequently, it is possible to determine whether to permit or deny access in accordance with the vehicle state at that point in time.

Note that central ECU 100 may also increase or decrease the value of the threshold for denying access, in accordance with the vehicle state of vehicle 10 and a service. For example, central ECU 100 may set the value of the threshold to cause the value to be greater from the vehicle state of “stopped”, “traveling”, and “self-driving” in stated order.

FIG. 13 is a flowchart showing the processing performed by master policy determiner 106 of central ECU 100 when maser policy determiner 106 collects policy verification results from zone ECUs 200a, 200b, 200c, and 200d, and a zone ECU that has sent a verification result different from those of the other zone ECUs is present (information processing method, access permission method) according to the present embodiment.

First, central ECU 100 determines whether any zone ECU is present that has responded with a different policy verification result, when central ECU 100 receives policy verification results from the zone ECUs such as 200a in step S306 or step S310 in the flowchart in FIG. 10 (S600). Stated differently, central ECU 100 determines whether central ECU 100 has received different policy verification results from the zone ECUs.

When a zone ECU that has responded with a different policy verification result is present (Yes in S600), central ECU 100 requests the zone ECU that has sent a different policy verification result for the version information of the access policy (S601). Central ECU 100 requests such zone ECU to send the version of the access policy. The version of the access policy is an example of the information related to the access policy. The information related to the access policy may be, for example, the date and time of updating the access policy.

Note that central ECU 100 may request all of the zone ECUs for the version of the access policy, rather than the zone ECU that has responded with a different policy verification result.

Next, upon receiving the version of the access policy from the zone ECU that has responded with a different policy verification result, central ECU 100 determines whether the received version information of the access policy differs from the version information of the access policy held by central ECU 100 itself (S602). In step S602, it may be determined, for example, whether the access policy held by each of the zone ECUs such as 200a is in synchronization with each other.

Note that central ECU 100 may compare the received version information of the access policy with the version of the access policy of other zone ECUs, rather than with the version information of the access policy held by central ECU 100 itself. Alternatively, central ECU 100 may hold in advance a list of items of version information of the access policy that are assumed to be used to verify whether the received version information of the access policy matches the version information of the access policy of the applicable zone ECU shown in the list.

When it is determined that the received version information of the access policy differs from the version information of the access policy held by central ECU 100 itself (Yes in S602), central ECU 100 updates the access policy of such zone ECU, regarding that the zone ECU is using an access policy different from the access policy assumed to be used (S603), and terminates the processing. For example, central ECU 100 may send the access policy held by central ECU 100 itself to each of the zone ECUs such as 200a (or to a zone ECU having a different access policy).

On the other hand, when it is determined that the received version information of the access policy is the same as the version information of the access policy held by central ECU 100 itself (No in S602), central ECU 100 determines that the zone ECU is exhibiting improper behavior, and then determines that future verification results (policy verification results) from such zone ECU will be ignored (or the weight will be decreased) (S604), and terminates the processing. “Ignore” may mean that, even when a policy verification result is received from such zone ECU, no processing will be performed on such policy verification result. “Ignore” may also mean, for example, that, even when a policy verification result is received from such zone ECU, such received policy verification result will not be used in obtaining the master policy verification result.

When it is determined that no zone ECU that has responded with a different verification result is present (No in S600), central ECU 100 terminates the processing.

Note that when a zone ECU exhibiting improper behavior is present, central ECU 100 may notify the external server of the presence of a zone ECU exhibiting improper behavior, or may record such anomaly in a log.

### Other Variations

The following describes variations other than those described above that are used in the in-vehicle network system according to the present embodiment, and a specific example of the image used for analysis when an unauthorized zone ECU is present, and so forth.

### Variation 1

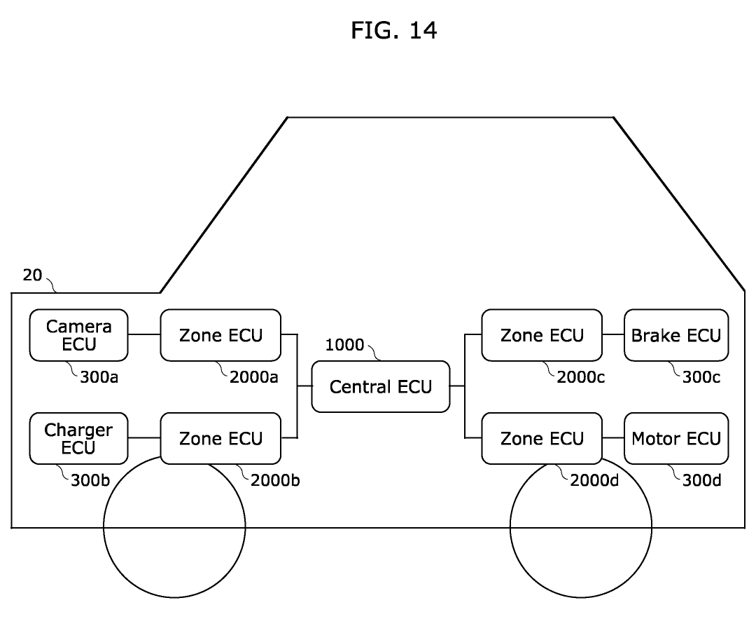

FIG. 14 is a diagram showing the overall configuration of an in-vehicle network system according to the present variation. In FIG. 14, the same reference signs are assigned to the same elements as those shown in FIG. 1.

The in-vehicle network system incorporated in vehicle 20 includes central ECU 1000 and zone ECUs 2000a, 2000b, 2000c, and 2000d, camera ECU 300a, charger ECU 300b, brake ECU 300c, and motor ECU 300d.

The following describes central ECU 1000 and zone ECUs 2000a, 2000b, 2000c, and 2000d.

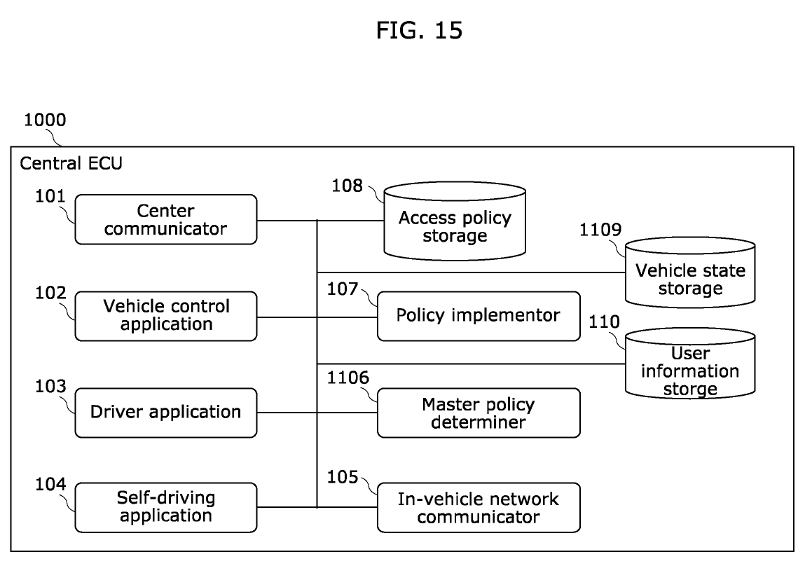

FIG. 15 is a block diagram showing the functional configuration of central ECU 1000 according to the present variation. Compared to central ECU 100 shown in FIG. 2 in the embodiment, information stored in vehicle state storage 1109 is different, and master policy determiner 1106 has an additional function in addition to the function of master policy determiner 106. Details of the information stored in vehicle state storage 1109 are described later with reference to FIG. 17.

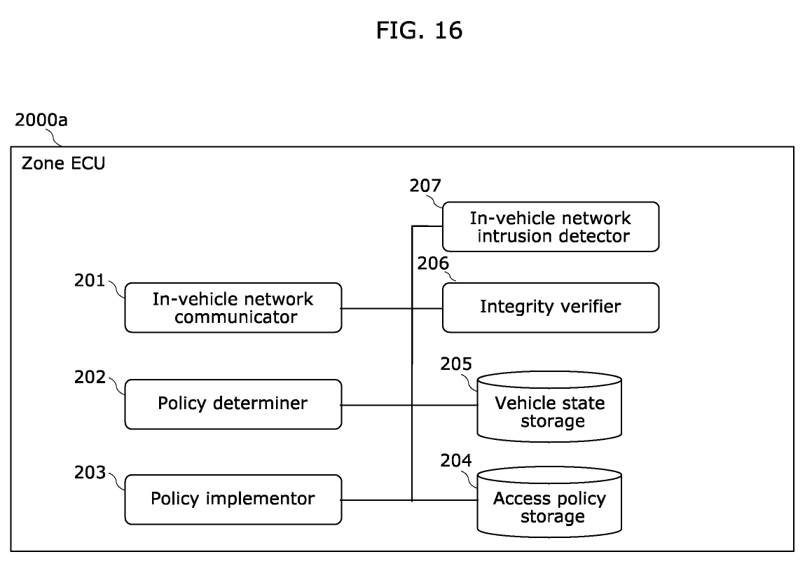

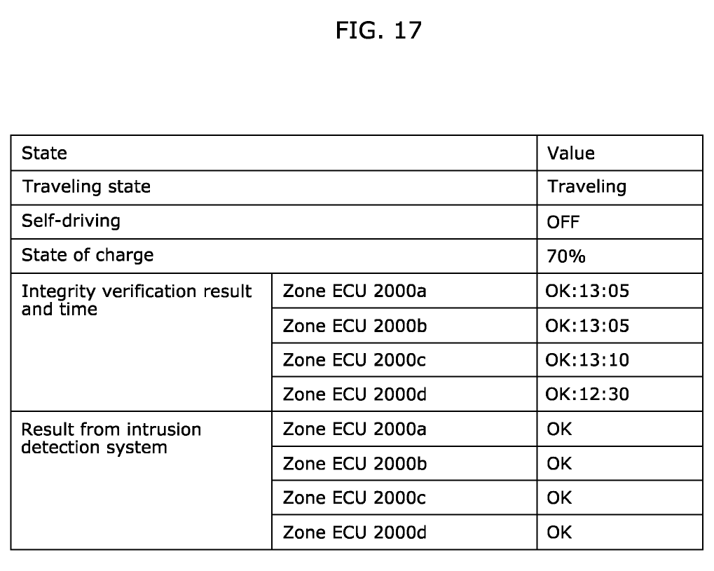

FIG. 16 is a block diagram showing the functional configuration of zone ECU 2000a according to the present variation. Compared to zone ECU 200a shown in FIG. 3 in the embodiment, integrity verifier 206 and in-vehicle network intrusion detector 207 are added as elements.

Integrity verifier 206 verifies that the functional configuration of zone ECU 2000a is not tampered with. More specifically, integrity verifier 206 compares a hash value that is calculated from software or the data constituting zone ECU 2000a with a hash value that is held in advance to verify that the software or the data of zone ECU 2000a is not tampered with. Integrity verifier 206 performs verification of the integrity (integrity verification) of the software or the data of zone ECU 2000a at regular or irregular time intervals while zone ECU 2000a is running. The integrity verification result is notified to central ECU 1000 via in-vehicle network communicator 201.

In-vehicle network intrusion detector 207 monitors in-vehicle network communications received by zone ECU 2000a to detect whether there is any anomalous communications. More specifically, in-vehicle network intrusion detector 207 detects, as an anomalous communication, receiving of a message from a sender or to a recipient not assumed, receiving of messages at a higher frequency than normal time, port scanning communication, diagnostic communication at improper timing, etc.

When an anomalous communication has been detected, in-vehicle network intrusion detector 207 notifies central ECU 1000 of the occurrence of such anomaly.

Note that zone ECUs 2000b, 2000c, and 2000d may also include both or only one of integrity verifier 206 and in-vehicle network intrusion detector 207. Also, it suffices if at least one of zone ECUs 2000a, 2000b, 2000c, or 2000d includes at least one of integrity verifier 206 or in-vehicle network intrusion detector 207.

FIG. 17 is a diagram showing an example of the vehicle state held by vehicle state storage 1109 of central ECU 1000 according to the present variation.

In addition to the information held in the vehicle state shown in FIG. 6, FIG. 17 shows that the following items notified from each of zone ECUs 2000a, 2000b, 2000c, and 2000d are held: the integrity verification result and the time; and the in-vehicle network intrusion detection result (result from an intrusion detection system). The in-vehicle network intrusion detection result indicates the results of detections performed by the in-vehicle network intrusion detection system.

The integrity verification result is held, for each of the ECUs, together with the time. FIG. 17 shows that: the integrity verification result from zone ECU 2000a is OK, indicating that the software or the data is not tampered with, and the last verification time is 13:05, the integrity verification result from zone ECU 2000b is OK, indicating that the software or the data is not tampered with, and the last verification time is 13:05; the integrity verification result from zone ECU 2000c is OK, indicating that the software or the data is not tampered with, and the last verification time is 13:10; the integrity verification result from zone ECU 2000d is OK, indicating that the software or the data is not tampered with, and the last verification time is 12:30.

The result from the in-vehicle network intrusion detection system is also held for each of the zone ECUs. The intrusion detection result from the in-vehicle network system of zone ECU 2000a is OK, indicating that no anomaly is detected. The intrusion detection result from the in-vehicle network system of zone ECU 2000b is OK, indicating that no anomaly is detected. The intrusion detection result from the in-vehicle network system of zone ECU 2000c is OK, indicating that no anomaly is detected. The intrusion detection result from the in-vehicle network system of zone ECU 2000d is OK, indicating that no anomaly is detected.

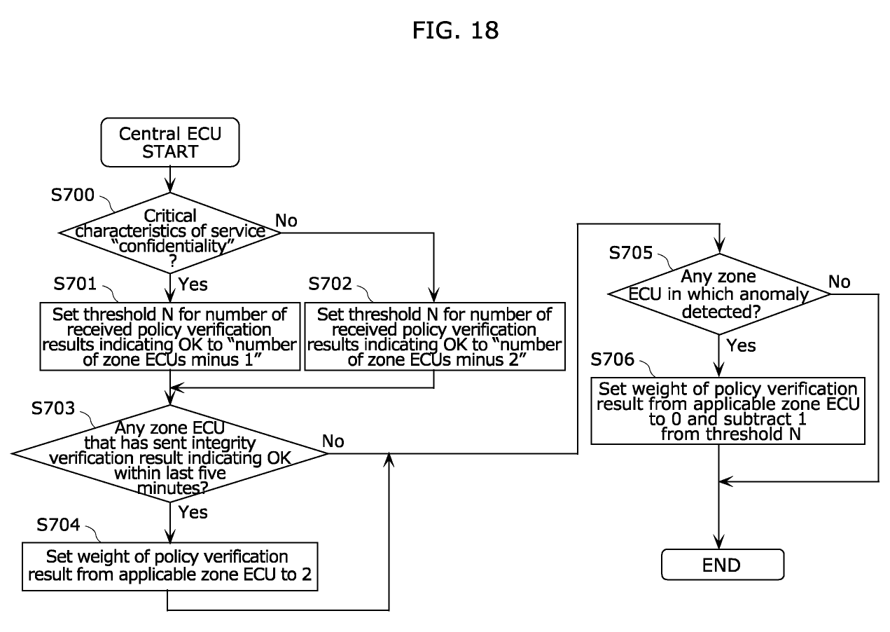

FIG. 18 is a flowchart showing the processing, performed by master policy determiner 1106 of central ECU 1000, of determining the thresholds used in steps S307 and S311 in the flowchart in FIG. 10 according to the present variation.

Note that the timings for determining the thresholds are not limited to specific timings. The thresholds may thus be calculated, for example, each time the thresholds are referenced to (stated differently, this processing may be performed immediately before step S307 or step S311), or processing for determining the thresholds may be performed in advance.

Central ECU 1000 determines whether the critical characteristics of the service subjected to access policy verification are confidentiality (S700).

When it is determined that the critical characteristics of the service subjected to access policy verification are confidentiality (Yes in S700), central ECU 1000 sets threshold N for the number of policy verification results indicating OK received from zone ECUs 2000a, 2000b, 2000c, and 2000d to “the number of zone ECUs deployed in the in-vehicle network system minus one”, which is 4 - 1 = 3 in the present variation (S701). Central ECU 1000 sets the value of threshold N for denying access to the service with the critical characteristics of confidentiality (second service), to a value smaller than a predetermined value. The predetermined value here is, for example, the value obtained by subtracting a predetermined number from the number of zone ECUs, but is not limited to this. Threshold N set in step S701 is the threshold used in step S307 in FIG. 10.

On the other hand, when it is determined that the critical characteristics of the service subjected to access policy verification are not confidentiality (No in S700), central ECU 1000 sets threshold N for the number of policy verification results indicating OK received from zone ECUs 2000a, 2000b, 2000c, and 2000d to “the number of zone ECUs deployed in the in-vehicle network system minus 2,” which is 4 – 2 = 2 in the present variation (S702). Central ECU 1000 sets threshold N for denying access to the service not with the critical characteristics of confidentiality (e.g., with the critical characteristics of availability) (first service), to a value greater than the predetermined value. The predetermined value here is, for example, the value obtained by subtracting a predetermined number from the number of zone ECUs, but is not limited to this. Threshold N set in step S702 is the threshold used in step S311 in FIG. 10.

Note that the values of thresholds N set in steps S701 and S702 are not limited to the values shown in FIG. 18. Threshold N set in step S701 is simply required to be set to a value relatively greater than the value of threshold N set in step S702.

Next, central ECU 1000 checks the vehicle state, verifies the integrity verification results from zone ECUs 2000a, 2000b, 2000c, and 2000d, and determines whether a zone ECU whose integrity verification result is OK is present within the last five minutes (S703). Note that “five minutes” is an example and is not limited to this.

When it is determined that a zone ECU whose integrity verification result is OK is present within the last five minutes (Yes in S703), central ECU 1000 sets (changes) the weight of the policy verification result (access OK/NG) received from such zone ECU to 2 (e.g., from 1 to 2) (S704). Since the policy determination result from a zone ECU determined to be Yes in step S703 is more credible than the policy determination result from a zone ECU determined to be No in step S703, and thus weight is increased. As described above, by setting the weight of a single zone ECU at normal time to 1, and setting the weight of a zone ECU from which a policy verification result OK is received to 2, master policy determiner 1106 counts the number of received policy verification results indicating OK in a manner in which receiving of a policy verification result indicating OK from a zone ECU whose integrity verification indicates OK is treated as equivalent to receiving of two policy verification results indicating OK.

Note that the weight is not limited to being increased from 1 to 2, and thus may be increased to any value greater than 1.

When it is determined that no zone ECU whose integrity verification result is OK is present within the last five minutes (No in S703), central ECU 1000 takes no particular action. Note that when the result in step S703 is No, central ECU 1000 may decrease the weight of the zone ECU concerned.

As described above, central ECU 1000 may increase or decrease the weight of the policy verification result received from a zone ECU on the basis of the integrity verification result received from such zone ECU.

Next, central ECU 1000 checks the vehicle state and determines whether a zone ECU is present in which an anomaly has been detected by the in-vehicle network intrusion detection system (S705).

When it is determined that a zone ECU is present in which an anomaly has been detected by the in-vehicle network intrusion detection system (Yes in S705), central ECU 1000 sets the weight of the policy verification result from such zone ECU to 0 (zero), subtracts 1 from the current threshold N (S706), and terminates the processing. By subtracting 1 from the current threshold N, it is possible to set a threshold appropriate for the case where a zone ECU with a weight of 0 is present.

Note that, when the result in step S705 is Yes, central ECU 1000 is not limited to setting the weight of the policy verification result to 0, and is simply required to decrease the value of the weight to a value smaller than the current value of the weight.

In step S706 the weight of the policy verification result is simply required to be decreased.

On the other hand, when it is determined that no zone ECU is present in which an anomaly has been detected by the in-vehicle network intrusion detection system (No in S705), central ECU 1000 terminates the processing. When the result in step S705 is No, central ECU 1000 may increase the weight of such zone ECU.

As described above, when central ECU 1000 receives a notification indicating that an anomalous communication has been detected from a zone ECU, central ECU 1000 may decrease the weight of the policy verification result received from such zone ECU.

With this, when a service Find message is subsequently received, it is possible to perform the processing shown in FIG. 10, etc., using the updated thresholds and weight obtained through the processing shown in FIG. 18.

Note that when a zone ECU whose integrity verification result is NG is present, the weight of the policy verification result from such zone ECU may be set to zero.

Furthermore, an example has been shown above in which the weight of the policy verification result from the zone ECU in which an anomaly has been detected by the in-vehicle network intrusion detection system is set to zero, but the weight of the policy verification result from such zone ECU may not be set to zero at this time. For example, threshold N may be increased for a message sent from an ECU in a zone where an anomaly has been detected. With this, it is possible to more carefully judge communications sent from an ECU located in the network where an anomaly has occurred, thereby enhancing the safety of the in-vehicle network.

### Variation 2

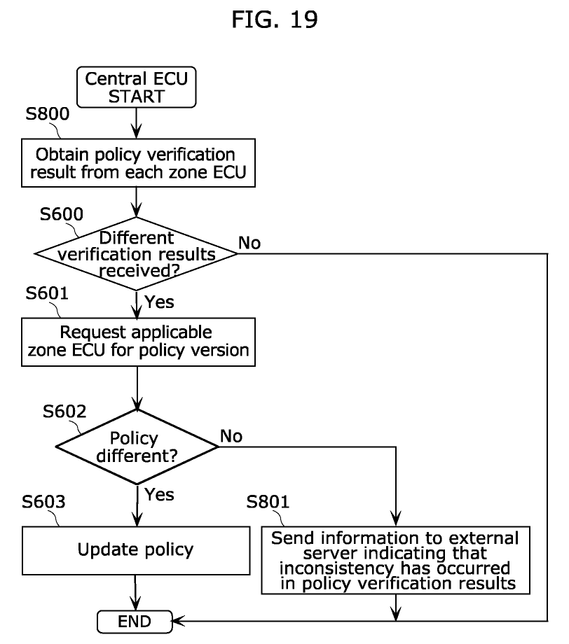

FIG. 19 is a flowchart showing the processing performed by master policy determiner 106 of central ECU 100 when maser policy determiner 106 collects policy verification results from zone ECUs 200a, 200b, 200c, and 200d, and a zone ECU that has sent a verification result different from those of the other zone ECUs is present (information processing method, access permission method) according to the present variation.

Note that FIG. 19 shows a flowchart in FIG. 13 in which step S800 is added, and step S604 is replaced with step S801.

First, central ECU 100 obtains policy verification results from the zone ECUs such as 200a (S800). Step S800 corresponds, for example, to step S306 or S310 shown in FIG. 10.

When it is determined that the received version information of the access policy is the same as the version information of the access policy held by central ECU 100 itself (No in S602), central ECU 100 sends, to the external server, information indicating that there is inconsistency in the policy verification results (S801). The information indicating that there is inconsistency in the policy verification results is an example of the verification information related to the master policy verification result. Furthermore, the sending of the information indicating that there is inconsistency in the policy verification results to the external server is an example of the outputting of the verification information.

When the result in step S602 is Yes, central ECU 100 may send, to the external server, at least one of the policy verification results or the version information of the access policy as the verification information related to the master policy verification result. The version information of the access policy is an example of the information for identifying a predetermined access policy.

With this, it is possible to display the verification information onto a display device connected to the external server. For example, it is possible to show the verification information to a monitoring person who is monitoring the in-vehicle network system.

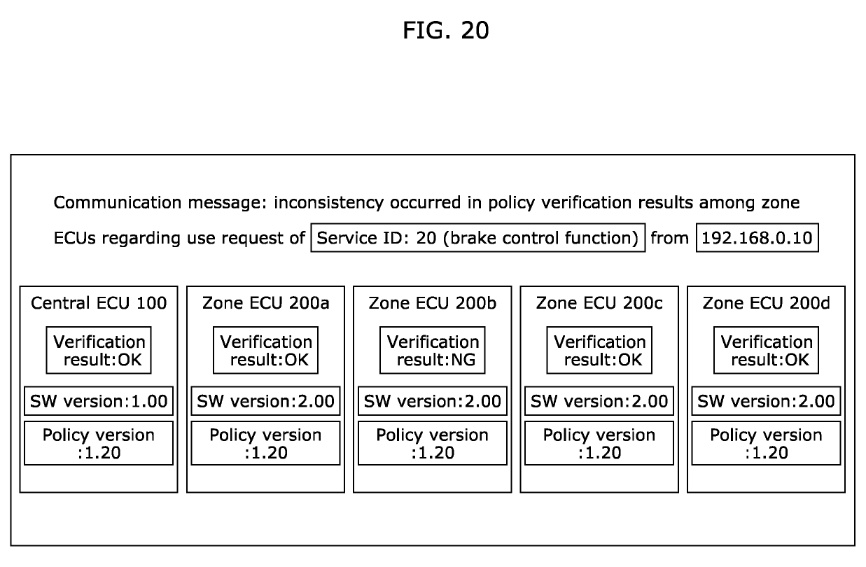

FIG. 20 is a diagram showing an example of the analysis screen that is used when a zone ECU with a different policy verification result is present and central ECU 100 notifies the external server of such situation, in response to which the external server judges the situation. FIG. 20 shows an example of the displayed verification information.

FIG. 20 shows the IP address information of an ECU that makes a service request when there is inconsistency in the policy verification results, and the result indicating which service such ECU has tried accessing (in the example of FIG. 20, the brake control function). Furthermore, a screen may be displayed that lists the verification results (policy verification results), the software versions (SW version), and the versions of the access policy (policy versions) for central ECU 100 and zone ECUs 200a, 200b, 200c, and 200d. It is known from FIG. 20 that all ECUs are using the same policy version, but only zone ECU 200b has responded with a verification result indicating NG, as a result of which there arises inconsistency in the policy verification results.

### Effects, etc.

The following shows examples of the techniques obtained from the descriptions of the present disclosure, and describes the effects, and others obtained from such techniques.

Technique 1. An information processing method executed by an information processing device in a control network system, wherein the control network system includes: a plurality of electronic control units each capable of executing a service that includes execution of predetermined processing, the plurality of electronic control units being capable of mutual access regarding services; and a plurality of edge access permission devices each determining whether to permit or deny the access based on a predetermined access policy, the information processing method including: obtaining, from the plurality of edge access permission devices, policy verification results, each including a determination result indicating whether the access is permitted or denied; and outputting verification information related to a master policy verification result that includes a final determination result indicating whether the access is permitted or denied, based on the policy verification results from the plurality of edge access permission devices.

In the foregoing embodiment, the access permission device is central ECU 100, and the edge access permission devices are zone ECUs 200a, 200b, 200c, and 200d.

Conventional access permission devices of this type determine whether to permit or deny access at a single access policy verification point. However, when the access policy or the program has been tampered with by an attacker, the verification of the access policy can be evaded. In view of this, the access permission device according to an aspect of the present disclosure makes the final determination of whether to permit or deny access by verifying distributed access policies at a plurality of verification points. With this, it is possible to make a highly reliable determination of whether to permit or deny access, thereby maintaining the security of the control network system. Stated differently, according to the access permission device, when the access permission device is applied to a target object (e.g., a vehicle) in which a control network system is incorporated, it is possible to realize a secure control network system while maintaining the safety of the target object.

Technique 2. The information processing method according to Technique 1, wherein the verification information is outputted to a display device to display the verification information onto the display device.

With this, by displaying the verification information onto the display device, it is possible to notify the administrator of the control network system of the master policy verification result.

Technique 3. The information processing method according to Technique 2, wherein the verification information includes: information for identifying the predetermined access policy of each of the plurality of edge access permission devices; and the policy verification results from the plurality of edge access permission devices.

With this, it is possible to notify the administrator of the control network system, for example, of whether an anomaly has occurred in the edge access permission devices, using information for identifying a predetermined access policy and the policy verification results.

Technique 4. The information processing method according to Technique 3, further including: displaying the verification information on the display device when there is inconsistency in the policy verification results from the plurality of edge access permission devices.

With this, it is possible to notify the administrator of the control network system of inconsistency in the policy verification results in the event of such inconsistency.

Technique 5. The information processing method according to any one of Techniques 1 to 4, wherein the access includes access made by one electronic control unit to a service of an other electronic control unit among the plurality of electronic control units, and the information processing method includes: when a total number of policy verification results indicating that the access is denied is at a threshold or more among the policy verification results from the plurality of edge access permission devices, sending the master policy verification result to an edge access permission device to which the one electronic control unit is connected and an edge access permission device to which the other electronic control unit is connected among the plurality of edge access permission devices, the master policy verification result indicating that the access is denied. Note that the threshold for denying the access is a threshold for the total number of received policy verification results indicating that the access is denied.

An ECU is able to access a service via, for example, SOME/IP communication. When the ECU sends a message requesting for a service not permitted, the plurality of zone ECUs such as 200a verify the access policy. As a result, the number of verification results indicating access denial becomes at the threshold or more, and such message is discarded and the access to the service is denied.

With this, it is possible for the zone ECU to control the access to the service on the basis of the final determination result that is made on the basis of the plurality of access policy verification results. This ensures the safety of the control network system.

Technique 6. The information processing method according to Technique 5, wherein the master policy verification result is sent to each of the plurality of edge access permission devices when the total number of policy verification results indicating that the access is denied is at the threshold or more.

With this, the master policy verification result is sent to each of the plurality of edge access permission devices. For this reason, when a zone ECU exhibiting strange behavior is present, it is possible to provide information about such zone ECU.

Technique 7. The information processing method according to any one of Techniques 1 to 4, wherein the predetermined access policy includes information related to at least one of an electronic control unit that is permitted to access the service or an electronic control unit that is permitted to provide the service among the plurality of electronic control units.

With this, it is possible to determine whether to permit or deny the access, using the access policy including information related to at least one of the ECU that is permitted to access the service or the ECU that is permitted to provide the service.

Technique 8. The information processing method according to Technique 5 or 6, wherein the service includes a first service requiring availability, and the information processing method includes: increasing a value of the threshold to a value greater than a predetermined value, the threshold being a threshold for denying the access to the first service.

With this, for a service requiring availability of data communication, it is possible to mitigate the impact of the violation of availability caused by an erroneous access denial. It is thus possible to ensure the availability of the network system while maintaining security.

Technique 9. The information processing method according to Technique 8, wherein the first service includes an exchange of sensor data.

With this, when the first service includes the exchange of sensor data, it is possible to ensure the availability of the network system while maintaining security.

Technique 10. The information processing method according to any one of Techniques 5 to 9, wherein the service includes a second service requiring confidentiality, and the information processing method includes: decreasing a value of the threshold to a value smaller than a predetermined value, the threshold being a threshold for denying the access to the second service.

With this, for a service requiring strict management of a recipient of data disclosure, it is possible to carefully determine whether to permit or deny the access, thus maintaining security.

Technique 11. The information processing method according to Technique 10, wherein the second service includes an exchange of data related to personal information or confidential information.

With this, when the second service includes the exchange of data, it is possible to ensure the security of the control network system.

Technique 12. The information processing method according to any one of Techniques 1 to 11, wherein the service includes a third service requiring safety, and the information processing method includes: permitting each of the plurality of edge access permission devices to determine whether to permit or deny the access to the third service, based on the policy verification result of the edge access permission device before the master policy verification result is outputted.

With this, for a service requiring real-time control, it is possible to perform the granting of access permission that minimizes processing delay caused by waiting for access policy verification results that are obtained at distributed points. This maintains both the security and real-time performance of the network system.

Technique 13. The information processing method according to Technique 12, wherein the third service includes a service related to control of an actuator.

With this, it is possible to maintain the security and real-time performance of the network system when the third service relates to the control of the actuator.

Technique 14. The information processing method according to Technique 5, wherein the control network system is an in-vehicle network system included in a vehicle, and the information processing method includes: increasing or decreasing a value of the threshold in accordance with a vehicle state of the vehicle and the service, the threshold being a threshold for denying the access.

With this, for a service whose characteristics to be prioritized change in accordance with the traveling state of the vehicle, it becomes possible to appropriately change the method of determining whether to permit or deny access. This enhances the security of the network system.

Technique 15. The information processing method according to Technique 14, wherein the vehicle state includes at least one of a traveling state, a charging state, an update state, a diagnostic mode state, or a self-driving mode.

With this, it is possible to set a threshold in response to at least one of the traveling state, the charging state, the update state, the diagnostic mode state, or the self-driving mode.

Technique 16. The information processing method according to any one of Techniques 1 to 15, wherein at least one edge access permission device among the plurality of edge access permission devices is configured to perform integrity verification for verifying that software or data of the at least one edge access permission device is not tampered with, and the information processing method includes: increasing or decreasing a weight of a policy verification result received from the at least one edge access permission device, based on a result of the integrity verification received from the at least one edge access permission device.

With this, by weighting and evaluating the access policy verification result from the edge access permission device that has been verified to be safe, it is possible to efficiently determine whether to permit or deny the access.

Technique 17 The information processing method according to any one of Techniques 1 to 16, wherein at least one edge access permission device among the plurality of edge access permission devices is configured to detect an anomalous communication, and the information processing method includes: decreasing a weight of a policy verification result received from the at least one edge access permission device when a notification is received from the at least one edge access permission device, the notification indicating that the anomalous communication has been detected.

With this, when an anomalous communication has been detected, the weight of the policy verification result received from the edge access permission device is decreased, thereby enabling an efficient determination of whether to permit or deny the access.

Technique 18. The information processing method according to any one of Techniques 1 to 17, including: when the plurality of edge access permission devices include an edge access permission device that sends a policy verification result different from the policy verification results of other edge access permission devices among the plurality of edge access permission devices, requesting to send information related to the predetermined access policy held by the edge access permission device.

With this, since policy verification results from all edge access permission devices are originality expected to be identical, it becomes possible to detect an edge access permission device exhibiting unexpected behavior and further investigate its cause. This enhances the security of the network system.

Technique 19 An information processing device in a control network system, wherein the control network system includes: a plurality of electronic control units each capable of executing a service that includes execution of predetermined processing, the plurality of electronic control units being capable of mutual access regarding services; and a plurality of edge access permission devices each determining whether to permit or deny the access based on a predetermined access policy, the information processing device including: an obtainer that obtains, from the plurality of edge access permission devices, policy verification results, each including a determination result indicating whether the access is permitted or denied; and an outputter that outputs verification information related to a master policy verification result that includes a final determination result indicating whether the access is permitted or denied, based on the policy verification results from the plurality of edge access permission devices.

According to the foregoing information processing device, it is possible to achieve similar effects as those achieved by the information processing method according to an aspect of the present disclosure.

Technique 20. A non-transitory computer-readable recording medium having recorded thereon a program for causing a computer to execute the information processing method according to any one of Techniques 1 to 18.

According to the foregoing program, it is possible to achieve similar effects as those achieved by the information processing method according to an aspect of the present disclosure.

Note that general or specific aspects of the present disclosure may be implemented using a system, a device, a method, an integrated circuit, a computer program, or a non-transitory computer-readable recording medium such as a CD-ROM, or any combination of systems, devices, methods, integrated circuits, computer programs, or recording media.

### Other Embodiments

The present disclosure has been described above on the basis of the embodiment, but the present disclosure is not limited to the foregoing embodiment.

For example, the control network system of the present disclosure is not limited to an in-vehicle network system, and thus may also include other mobility network systems and/or control network systems. Furthermore, the communication standards used in such a system are not limited to specific communication standards. Also, the architecture of the in-vehicle communication network system is not limited to the example shown in FIG. 1.

Furthermore, the target object in which the control network system is incorporated is not limited to a mobile object such as a vehicle, and thus may also be a non-mobile object such as a facility. The facility is a target object in which, for example, a home network system is incorporated, which is an example of the control network system. The facility may also be, for example, a residence, a hospital, a building, a nursing care facility, a school, etc.

Furthermore, an example has been described above in which each of the zone ECUs includes the policy determiner and the policy implementor, but the policy determiner and the policy implementor may also be provided other than in the zone ECUs. The policy determiner and the policy implementor may be provided, for example, in an ECU, a network switch, and a network gateway. Furthermore, the master policy determiner does not need to be provided in the central ECU. The master policy determiner may be provided, for example, in an ECU having an execution environment whose security level is different from those of normal applications.

Furthermore, when an ECU is present whose access policy storage and policy determiner are not able to receive messages subjected to policy verification, such as a camera information service discovery message in the foregoing embodiment, due to a reason such as broadcast failure, the target message may be forwarded to such ECU to request policy verification.

Furthermore, the foregoing embodiment has described an example in which each of the zone ECUs that has received a discovery message, such as a camera information service discovery message, verifies the access policy, but the present disclosure is not limited to this. It suffices if two or more zone ECUs among the plurality of zone ECUs that have received the discovery message verify the access policy.

Furthermore, the present disclosure may also be implemented in the form of an access permission device incorporated in a target object. The target object includes: an ECU in which the access permission device is provided; and at least one zone ECU (e.g., the zone ECUs such as 200a) that is controlled by the ECU and controls a device included in the target object. The access permission device includes: when a sender (or provider) in the target object sends an access request (e.g., access request for accessing a service) to a recipient in the target object, an obtainer (e.g., center communicator) that obtains a policy verification result, which is a determination result that is obtained on the basis of a predetermined access policy and indicates whether access is permitted or denied in response to the access request; and a master policy determiner that makes a final determination of whether to permit or deny the access in response to the access request, on the basis of the policy verification result obtained from each of the at least one zone ECU.

Furthermore, the present disclosure may also be implemented in the form of an access permission method executed by an access permission device incorporated in a target object. The target object includes: an ECU in which the access permission device is provided; and at least one zone ECU (e.g., the zone ECUs such as 200a) that is controlled by the ECU and controls a device included in the target object. The access permission method includes: when a sender (or provider) in the target object sends an access request (e.g., access request for accessing a service) to a recipient in the target object, obtaining a policy verification result, which is a determination result that is obtained on the basis of a predetermined access policy and indicates whether access is permitted or denied in response to the access request, the obtaining being performed by each of the at least one zone EUC; and making a final determination of whether to permit or deny the access in response to the access request, on the basis of the policy verification result obtained from each of the at least one zone ECU.

Furthermore, the foregoing embodiment has described an example in which the target object in which the control network system is incorporated is a mobile object such as a vehicle, but the present disclosure is not limited to this. The control network system may also be incorporated in a stationary target object.

Furthermore, the communication method and the communication standards used between devices in the foregoing embodiment are not limited to a specific communication method and specific communication standards. Communication between devices may be performed via wireless communication or wired communication. In addition, communication between devices may be a combination of wireless communication and wired communication.

Furthermore, all of the numerics used above are provided to specifically describe the present disclosure, and thus the embodiment of the present disclosure is not limited to the illustrated numerics.

Also, the division of the functional blocks in the block diagrams is an example, and thus a plurality of functional blocks may be realized in the form of a single functional block, a single functional block may be divided into a plurality of blocks, or some of the functions may be moved to another functional block. Also, the functions of a plurality of functional blocks having similar functions may be processed by hardware or software in parallel or in a time-shared manner.

The orders of performing the steps in the flowcharts are examples to specifically describe the present disclosure, and thus may be orders other than the foregoing orders. Also, some of the steps may be performed simultaneously (in parallel) with another step.

Also, for example, the elements included in each of the devices described in the foregoing embodiment may be distributed across a plurality of devices in any manner without departing from the essence of the present disclosure.

Also, in the foregoing embodiment, a process performed by a specified processing unit may be performed by another processing unit. Also, the processing order of a plurality of processes may also be changed, and a plurality of processes may be performed in parallel.

Each of the elements (each of the processing units) in the foregoing embodiment may be realized by executing a software program suitable for the element. Each of the elements may be realized by means of a program executing unit, such as a Central Processing Unit (CPU) and a processor, reading and executing the software program recorded on a recording medium such as a hard disk or a semiconductor memory.

Each of the elements may also be configured in the form of a hardware product. Also, each of the elements may be a circuit (or an integrated circuit). Each of the circuits may be configured in the form of one circuit as a whole, or in the form of individual circuits. Each of the circuits may be a general-purpose circuit or an exclusive circuit.

Note that general or specific aspects of the present disclosure may be implemented using a system, a device, a method, an integrated circuit, a computer program, or a non-transitory computer-readable recording medium such as a CD-ROM, or any combination of systems, devices, methods, integrated circuits, computer programs, or recording media.

The scope of the present disclosure also includes an embodiment achieved by making various modifications to the embodiment that can be conceived by those skilled in the art or an embodiment achieved by freely combining some of the elements and functions in each embodiment without departing from the essence of the present disclosure.

### INDUSTRIAL APPLICABILITY

The present disclosure is applicable for use as a control device that controls vehicles.

1. An information processing method executed by an information processing device in a control network system,
wherein the control network system includes:
a plurality of electronic control units each capable of executing a service that includes execution of predetermined processing, the plurality of electronic control units being capable of mutual access regarding services; and
a plurality of edge access permission devices each determining whether to permit or deny the access based on a predetermined access policy,
the information processing method comprising:
obtaining, from the plurality of edge access permission devices, policy verification results, each including a determination result indicating whether the access is permitted or denied; and
outputting verification information related to a master policy verification result that includes a final determination result indicating whether the access is permitted or denied, based on the policy verification results from the plurality of edge access permission devices.

2. The information processing method according to claim 1,
wherein the verification information is outputted to a display device to display the verification information onto the display device.

3. The information processing method according to claim 2,
wherein the verification information includes: information for identifying the predetermined access policy of each of the plurality of edge access permission devices; and the policy verification results from the plurality of edge access permission devices.

4. The information processing method according to claim 3,
displaying the verification information on the display device when there is inconsistency in the policy verification results from the plurality of edge access permission devices.

5. The information processing method according to claim 1,
wherein the access includes access made by one electronic control unit to a service of an other electronic control unit among the plurality of electronic control units, and
the information processing method comprises:
when a total number of policy verification results indicating that the access is denied is at a threshold or more among the policy verification results from the plurality of edge access permission devices, sending the master policy verification result to an edge access permission device to which the one electronic control unit is connected and an edge access permission device to which the other electronic control unit is connected among the plurality of edge access permission devices, the master policy verification result indicating that the access is denied.

6. The information processing method according to claim 5,
wherein the master policy verification result is sent to each of the plurality of edge access permission devices when the total number of policy verification results indicating that the access is denied is at the threshold or more.

7. The information processing method according to claim 1,
wherein the predetermined access policy includes information related to at least one of an electronic control unit that is permitted to access the service or an electronic control unit that is permitted to provide the service among the plurality of electronic control units.

8. The information processing method according to claim 5,
wherein the service includes a first service requiring availability, and
the information processing method comprises:
increasing a value of the threshold to a value greater than a predetermined value, the threshold being a threshold for denying the access to the first service.

9. The information processing method according to claim 8,
wherein the first service includes an exchange of sensor data.

10. The information processing method according to claim 5,
wherein the service includes a second service requiring confidentiality, and
the information processing method comprises:
decreasing a value of the threshold to a value smaller than a predetermined value, the threshold being a threshold for denying the access to the second service.

11. The information processing method according to claim 10,
wherein the second service includes an exchange of data related to personal information or confidential information.

12. The information processing method according to claim 1,
wherein the service includes a third service requiring safety, and
the information processing method comprises:
permitting each of the plurality of edge access permission devices to determine whether to permit or deny the access to the third service, based on the policy verification result of the edge access permission device before the master policy verification result is outputted.

13. The information processing method according to claim 12,
wherein the third service includes a service related to control of an actuator.

14. The information processing method according to claim 5,
wherein the control network system is an in-vehicle network system included in a vehicle, and
the information processing method comprises:
increasing or decreasing a value of the threshold in accordance with a vehicle state of the vehicle and the service, the threshold being a threshold for denying the access.

15. The information processing method according to claim 14,
wherein the vehicle state includes at least one of a traveling state, a charging state, an update state, a diagnostic mode state, or a self-driving mode.

16. The information processing method according to claim 1,
wherein at least one edge access permission device among the plurality of edge access permission devices is configured to perform integrity verification for verifying that software or data of the at least one edge access permission device is not tampered with, and
the information processing method comprises:
increasing or decreasing a weight of a policy verification result received from the at least one edge access permission device, based on a result of the integrity verification received from the at least one edge access permission device.

17. The information processing method according to claim 1,
wherein at least one edge access permission device among the plurality of edge access permission devices is configured to detect an anomalous communication, and
the information processing method comprises:
decreasing a weight of a policy verification result received from the at least one edge access permission device when a notification is received from the at least one edge access permission device, the notification indicating that the anomalous communication has been detected.

18. The information processing method according to claim 1, comprising:
when the plurality of edge access permission devices include an edge access permission device that sends a policy verification result different from the policy verification results of other edge access permission devices among the plurality of edge access permission devices, requesting to send information related to the predetermined access policy held by the edge access permission device.

19. An information processing device in a control network system,
wherein the control network system includes:
a plurality of electronic control units each capable of executing a service that includes execution of predetermined processing, the plurality of electronic control units being capable of mutual access regarding services; and
a plurality of edge access permission devices each determining whether to permit or deny the access based on a predetermined access policy,
the information processing device comprising:
an obtainer that obtains, from the plurality of edge access permission devices, policy verification results, each including a determination result indicating whether the access is permitted or denied; and
an outputter that outputs verification information related to a master policy verification result that includes a final determination result indicating whether the access is permitted or denied, based on the policy verification results from the plurality of edge access permission devices.

20. A non-transitory computer-readable recording medium having recorded thereon a program for causing a computer to execute the information processing method according to claim 1.
